(19) United States
(12) Patent Application Publication
(10) Pub. No.: US 2024/0354774 A1
(43) Pub. Date: Oct. 24, 2024

(54) SYSTEM AND METHOD OF IMMUTABLE ELECTRONIC PROCESSING OF RENEWABLE ENERGY PRODUCTION DATA FOR ISSUING DIGIRECs

(71) Applicant: CARBON PESA LIMITED, HARROW WEALD (GB)

(72) Inventors: ELVIN MUTUMA MARANGU, HARROW WEALD (GB); AMEET LALCHAND SHAH, HARROW WEALD (GB)

(73) Assignee: CARBON PESA LIMITED, HARROW WEALD, KH (GB)

(21) Appl. No.: 18/640,506

(22) Filed: Apr. 19, 2024

Related U.S. Application Data
(60) Provisional application No. 63/497,975, filed on Apr. 24, 2023.

(51) Int. Cl. G06Q 30/018; H02J 3/38

(52) U.S. Cl. CPC G06Q 30/018; H02J 3/381; H02J 2300/24; H02J 2300/28

(57) ABSTRACT

A system of immutable electronic processing of renewable energy production data for issuing Digital Renewable Energy Certificates (DIGIRECs) for electricity includes a central cloud server that periodically acquires a plurality of renewable energy production datasets from a renewable energy metering and monitoring device located at a renewable energy production source site. The central cloud server assigns a timestamp and a hash value to each renewable energy production dataset, generates an electronically verifiable span data package, processes the electronically verifiable span data package to generate a renewable energy certificate (REC) claim request, and communicates the REC claim request to a first third-party system. The central cloud server further acquires a unique identifier of a first REC from the first third-party system when the REC claim request is successfully verified and generates an interactive digital renewable energy certificate (DIGIREC) asset based on predefined REC-taxonomy metadata and the acquired unique identifier.

### CROSS-REFERENCE TO RELATED APPLICATIONS/INCORPORATION BY REFERENCE

This Application makes reference to, claims benefit from, and claims priority to U.S. Provisional Application Ser. No. 63/497,975, which was filed on Apr. 24, 2023.

The above referenced Application is hereby incorporated herein by reference in its entirety.

### FIELD OF TECHNOLOGY

The present disclosure relates generally to the field of renewable energy management systems and, more specifically, to a system and a method of immutable electronic processing of renewable energy production data for issuing Digital Renewable Energy Certificates (“DIGIRECs”) for electricity.

### BACKGROUND

In recent years, there has been a concerted global effort to transition towards renewable energy sources as a pivotal strategy to combat climate change and reduce dependence on fossil fuels. The transition towards renewable energy sources has spurred the creation of various renewable energy certification systems aimed at monitoring and validating the generation and consumption of renewable energy. Typically, the generation of renewable energy certificates (RECs) is governed by analog, trust-based systems, where energy producers self-report their renewable energy production either manually or using a paper-based approach. The reliance on self-reporting includes a lot of human touch points, which may lead to potential inaccuracies. Moreover, the conventional methods and systems associated with the issuance of RECs have typically involved manual or paper-based procedures, encompassing project registration, physical metering, and manual verification processes conducted by designated authorities.

Involving third-party verification of RECs and the development of international standards has addressed some of the challenges faced in relation to certification. However, the third-party verification of RECs and adoption of international standards is partially implemented, leading to fragmentation and inconsistency in the renewable energy market. For example, reliably capturing and tracking renewable energy production data at renewable energy installation sites without any potential for inaccuracies remains a technical challenge.

Further limitations and disadvantages of conventional and traditional approaches will become apparent to one of skill in the art through comparison of such systems with some aspects of the present disclosure as set forth in the remainder of the present application with reference to the drawings.

### BRIEF SUMMARY OF THE DISCLOSURE

A system and a method of immutable electronic processing of renewable energy production data for issuing digital renewable energy certificates (DIGIRECs) for electricity, substantially as shown in and/or described in connection with at least one of the figures, as set forth more completely in the claims. The disclosed system and method ensure transparency and accountability in renewable energy production. The disclosed system and method provide a technology-based solution that provides transparency and assurance to end-to-end workflow involved in the production, tracking, and verification of the renewable energy production at renewable energy installations and further issuance of an improved form of Renewable Energy Certificates (RECs), called “DIGIRECs” for electricity, which is compatible to a REC issuing entity standard. Embodiments of the present disclosure substantially eliminate or at least partially address the aforementioned problems in the prior art and improve the tracking, validating and verifying the renewable energy production and improve the transparency of issuing Digital Renewable Energy Certificates (DIGIRECs) for electricity.

These and other advantages, aspects, and novel features of the present disclosure, as well as details of an illustrated embodiment thereof, will be more fully understood from the following description and drawings.

### BRIEF DESCRIPTION OF DRAWINGS

Embodiments of the present disclosure will now be described, by way of example only, with reference to the following diagrams wherein:

FIG. 1A is a diagram illustrating various exemplary components of a system of immutable electronic processing of renewable energy production data for issuing Digital Renewable Energy Certificates (DIGIRECs) for electricity, in accordance with an embodiment of the present disclosure;

FIG. 1B is a diagram illustrating interoperability of various components of a system of immutable electronic processing of renewable energy production data for issuing DIGIRECs for electricity, in accordance with an embodiment of the present disclosure;

FIG. 2 is a diagram illustrating various exemplary components of a central cloud server, in accordance with an embodiment of the present disclosure;

FIG. 3 is a diagram illustrating various exemplary components of a renewable energy metering and monitoring device, in accordance with an embodiment of the present disclosure;

FIGS. 4A and 4B collectively, is a diagram illustrating an exemplary implementation scenario of a flow of issuing an interactive DIGIREC asset for electricity corresponding to generation of a relative unit of electricity using renewable energy, in accordance with an embodiment of the present disclosure;

FIG. 5 is a diagram illustrating an electronically verifiable span data package, in accordance with an embodiment of the present disclosure;

FIG. 6 is a diagram illustrating lifecycle of an interactive DIGIREC asset, in accordance with an embodiment of the present disclosure;

FIG. 7 is a diagram illustrating various features of an interactive DIGIREC asset, in accordance with an embodiment of the present disclosure; and

FIGS. 8A, 8B and 8C collectively, is a diagram illustrating a flowchart of a method of immutable electronic processing of renewable energy production data for issuing Digital Renewable Energy Certificates (DIGIRECs) for electricity, in accordance with an embodiment of the present disclosure.

### DETAILED DESCRIPTION OF THE DISCLOSURE

Certain embodiments of the disclosure may be found in a system and a method of immutable electronic processing of renewable energy production data for issuing digital renewable energy certificates (DIGIRECs) for electricity.

In conventional systems and methods, typically, the entity that generates the renewable energy typically self-reports on the energy production or carbon reduction activity. The self-reporting may be prone to errors. Currently, it is technically challenging to accurately validate the renewable energy production information at the source of production site to a granular level in a reliable manner.

In contrast to the conventional systems, the disclosed system and method covers the entire lifecycle of renewable energy production data in a holistic approach, from accurate, timely and tamper-resilient recording of the renewable energy data produced at a renewable energy production source site to monitoring and verifying the reported values of the actual renewable energy produced at the renewable energy production source site. A special-purpose device is installed at the renewable energy production source point within the site, referred to as a renewable energy metering and monitoring device for the tamper-resilient recording and measurement of the data for the renewable energy produced at the renewable energy production source site. An amount of renewable energy produced by a list of renewable energy generation devices at the renewable energy production source site when converted to alternating current (AC) for electricity via inverters is read directly by the renewable energy metering and monitoring device in a secured device-to-device communication between the renewable energy metering and monitoring device and the inverters. The renewable energy production datasets of the renewable energy production source site are acquired not from a user due to self-reporting, but are acquired directly from the renewable energy metering and monitoring device located at the renewable energy production source site. From this initial acquisition to all electronic processing operations, including monitoring, verification, and final issuing of interactive DIGIREC assets is immutable. The immutable refers to a property or nature of the system that ensures that the recorded and processed data cannot be tampered with or altered, providing transparency and integrity in the verification process of renewable energy production at renewable energy installations. Thus, the immutable electronic processing of renewable energy production data for issuing DIGIRECs for electricity not only prevents any vulnerability of the certification process, but also improves accurate, timely and efficient tracking, validation, and verification of the renewable energy production at the renewable energy installations. The disclosed system and method eliminate the chances of human error in data reporting, or data manipulation related to the renewable energy production at the renewable energy installations.

Furthermore, the disclosed system and method enable accurate validation and verification of the renewable energy production information at the source of the production site to a granular level in a reliable manner, for example, by providing authenticated and tamper-resilient renewable energy production data. The term tamper-resilient may indicate that the renewable energy production information is difficult to tamper with and if a tampering attempt is made, it can be detected using the previously generated hash value of renewable energy production information (as the hash value will change if any tampering attempt is done). The use of authenticated and tamper-resilient renewable energy production data may contribute to levelling the playing field in the renewable energy sector for new entrants or geographically distanced renewable energy suppliers, for example, Global South, by reducing information asymmetry between established players and new entrants. By leveraging electronic processing and verification, the disclosed system and method ensure the reliability and scalability of renewable energy certificates, contributing to more effective carbon reduction efforts and positive climate change impacts.

In the following description, reference is made to the accompanying drawings, which form a part hereof, and in which are shown, by way of illustration, various embodiments of the present disclosure.

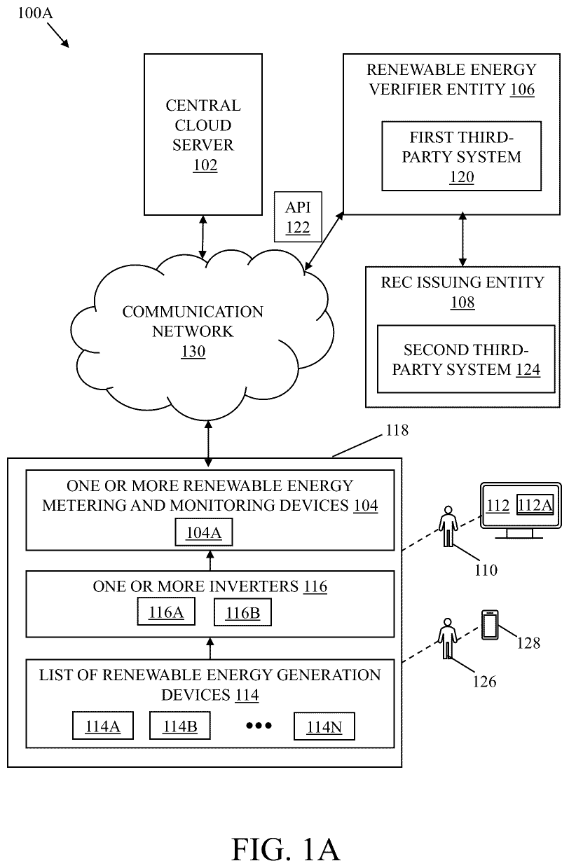

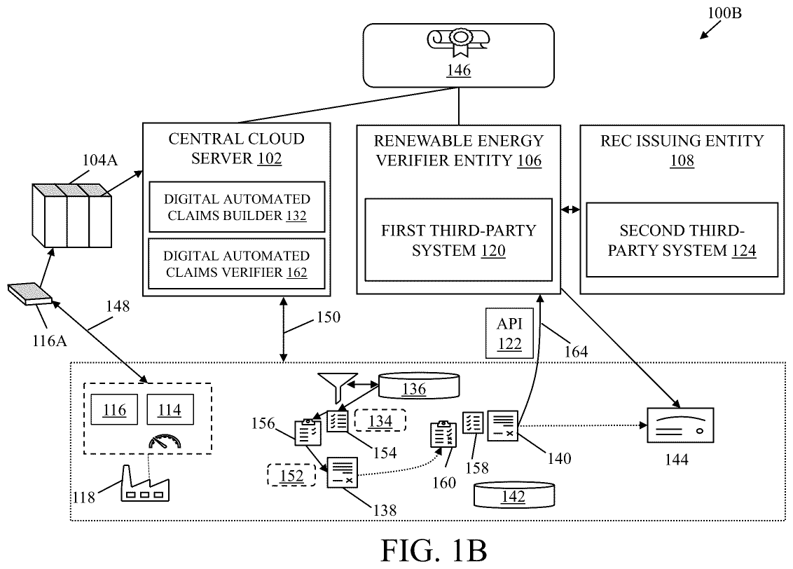

FIG. 1A is a diagram illustrating various exemplary components of a system of immutable electronic processing of renewable energy production data for issuing Digital Renewable Energy Certificates (DIGIRECs) for electricity, in accordance with an embodiment of the present disclosure. With reference to FIG. 1A, there is shown a system 100A of immutable electronic processing of renewable energy production data for issuing DIGIRECs for electricity. The system 100A may include a central cloud server 102 and one or more renewable energy metering and monitoring devices 104. There is further shown a renewable energy certificate (REC) issuing entity 108. A renewable energy production source site 118 may include a list of renewable energy generation devices 114, one or more inverters 116 and the one or more renewable energy metering and monitoring devices 104. There is further shown a user 110 associated with the renewable energy production source site 118. The user 110 may be an operator who may operate a user device 112 to register various devices at the renewable energy production source site 118, via a front-end interface 112A rendered at the user device 112.

The renewable energy verifier entity 106 (e.g., “the Evident registry”) may include a first third-party system 120 which may interact with the central cloud server 102 via an application programming interface (API) 122. Optionally, the REC issuing entity 108 may include a second third-party system 124. There is further shown a registered entity 126 (e.g., an owner of the renewable energy production source site 118) who may own or operate another user device 128. In the system 100A, a communication network 130 may facilitate communication of data between each of the central cloud server 102, the renewable energy production source site 118, and the renewable energy verifier entity 106. In practice, the central cloud server 102 may not directly interact with the REC issuing entity 108 or its sub-systems, such as the second third-party system 124. The renewable energy verifier entity 106 may interact with the REC issuing entity 108 and facilitate the acquisition of a unique identifier of a REC and communicate back to the central cloud server 102.

In the FIG. 1A, the list of renewable energy generation devices 114 may include ‘N’ number of renewable energy generation devices, for example, a first renewable energy generation device 114A, a second renewable energy generation device 114B, up to a Nth renewable energy generation device 114N, where N is a positive definite number. The one or more inverters 116 may include for example, a first inverter 116A and a second inverter 116B. The one or more renewable energy metering and monitoring devices 104 may include, for example, a renewable energy metering and monitoring device 104A. In FIG. 1A, merely one renewable energy metering and monitoring device (i.e., the renewable energy metering and monitoring device 104A) is shown, for sake of brevity. Each renewable energy production source site 118 may include more than one renewable energy metering and monitoring device depending on need, such as depending on the number of inverters that may be required to be connected to the renewable energy metering and monitoring device 104A.

In the FIG. 1A, there is provided the system 100A of immutable electronic processing of renewable energy production data for issuing DIGIRECs for electricity. The immutable electronic processing may refer to electronic processing of the renewable energy production data in such a way that any alteration or modification is prevented throughout the process or any tampering is very difficult (i.e. tamper-resilient), starting from initial recording of the renewable energy production data, through intermediate processing, up to issuance of DIGIRECs and even post handling of DIGIRECs after issuance. The immutable (may be also referred to as tamper-resilient) electronic processing ensures the integrity and reliability of the renewable energy production data. The immutable electronic processing may be achieved through device-to-device communication between the one or more renewable energy metering and monitoring devices 104 and the one or more inverters 116 for initial capture and acquisition of raw renewable energy production data, and further use of cryptographic techniques, ensuring that the renewable energy production data remains unchanged and verifiable over time. The system 100A provides a transparent and an electronically verifiable trusted resource for accountability of issued DIGIRECs (an improved form of renewable energy certificates). Moreover, the system 100A eliminates the reliance on self-reported data and provides continuous independent verification and reduces the probability of any data manipulation through the end-to-end workflow or process.

Advantageously, the system 100A enables the verification of the renewable energy production data at a granular level by providing comprehensive detail regarding the renewable energy production data. The system 100A also enables the integration of renewable energy certificates into markets, including those in Global South countries with less established electrical grids, and facilitates accurate carbon emission monitoring. Overall, the system 100A addresses the limitations of existing analog or manual systems and enhances the trustworthiness and reliability of renewable energy certificates using a technically advanced system, such as the system 100A.

The central cloud server 102 may include suitable logic, circuitry, interfaces and/or code that is configured to periodically acquire a list of renewable energy production datasets from the renewable energy metering and monitoring device 104A located at the renewable energy production source site 118. In an implementation, the central cloud server 102 may be a master cloud server that may be a part of a data center which controls an array of other cloud servers communicatively coupled to the data center for load balancing, running customized applications, and efficient data management. Examples of the central cloud server 102 may include, but are not limited to, an application server, a cloud server, a file server, a web server, a storage server, a virtualization server, or a combination of aforementioned servers.

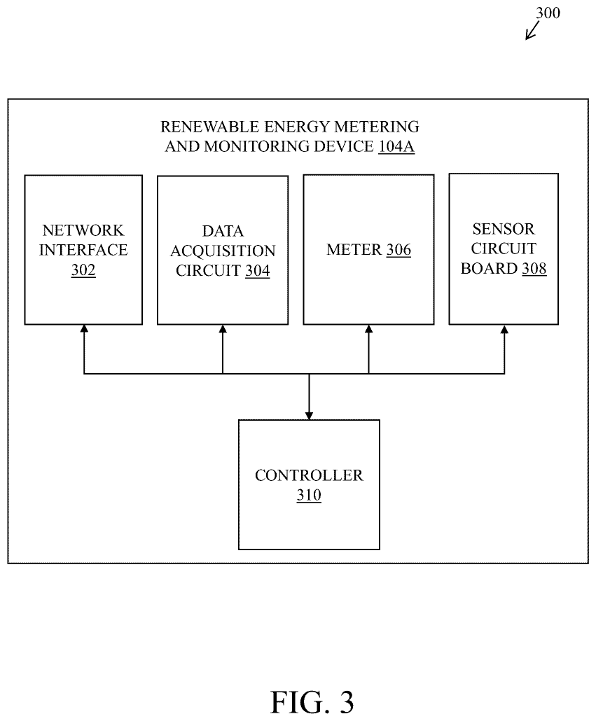

Each of the one or more renewable energy metering and monitoring devices 104 may include suitable logic, circuitry, interfaces and/or code that is configured to communicate with the one or more inverters 116 located at the renewable energy production source site 118 and the central cloud server 102. Each of the one or more renewable energy metering and monitoring devices 104, such as the renewable energy metering and monitoring device 104A may be configured to acquire, monitor and track the renewable energy. In an implementation, the renewable energy metering and monitoring device 104A may be installed inside a secure case (at the renewable energy production source site 118) that is locked to prevent any unauthorized access to any individual either working at the renewable energy production source site 118 or prevent any unauthorized remote access other than the central cloud server 102. Examples of implementation of the one or more renewable energy metering and monitoring devices 104 may include, but are not limited to, a special purpose Internet-of-Things (IoT) device, an IoT controller, and the like. The renewable energy metering and monitoring device 104A may have an electrical meter (or a smart meter) and a data acquisition circuit that is in line with the AC electricity produced and transmitted by the one or more inverters 116. The renewable energy metering and monitoring device 104A is described in more detail, for example, in FIG. 3.

The renewable energy verifier entity 106 may include suitable logic, circuitry, interfaces and/or code that is configured to receive a renewable energy certificate (REC) claim request from the central cloud server 102 and perform verification of REC claim request. The renewable energy verifier entity 106 may include the first third-party system 120 including the API 122 through which, the first third-party system 120 may receive the REC claim request and interact or communicate with the central cloud server 102. Furthermore, the renewable energy verifier entity 106 may separately (without any intervention from the central cloud server 102) may interact with the REC issuing entity 108 (e.g., the issuer) In an example, the renewable energy verifier entity 106 may be the entity responsible for verification and facilitating issuance of RECs (e.g., in coordination with the REC issuing entity 108) without limiting the scope of the disclosure.

The REC issuing entity 108 may include suitable logic, circuitry, interfaces and/or code that is configured to issue the first REC, which is facilitated in coordination with the renewable energy verifier entity 106. The REC issuing entity 108 (i.e., issuer) may include the second third-party system 12. In practice, the central cloud server 102 may not interact or directly communicate with the REC issuing entity 108. The central cloud server 102 interacts and communicates with the renewable energy verifier entity 106 via the API 122 for all verification services and receipt of the unique identifier of a given REC for “DIGIREC” generation purposes. The REC issuing entity 108 may be different in different jurisdictions or countries, without limiting the scope of the disclosure.

The user 110 may be an operator responsible for managing or operating the renewable energy production source site 118. Examples of the user device 112 may be a laptop, a desktop, a smart phone, and the like. The front-end interface 112A may be rendered at the user device 112. In an example, the front-end interface 112A may correspond to a web-based dashboard accessible through a browser on the user device 112, where the dashboard may display information, such as energy production levels, present status of each of the list of renewable energy generation devices 114, and historical data related to the energy production levels in a user-friendly format.

Each of the list of renewable energy generation devices 114 may be configured to harness naturally occurring and replenishable energy sources to produce electricity or other forms of energy without depleting finite resources and causing significant harm to the environment. Examples of the list of renewable energy generation devices 114 installed at the renewable energy production source site 118 may include, but are not limited to, solar panels, wind turbines, tidal turbines, hydroelectric dams, biomass power plants, geothermal power plants, solar water heaters, wave energy converters, and the like.

Each of the one or more inverters 116 may be a power electronic device installed at the renewable energy production source site 118 that is configured to convert direct current (DC) generated by each of the list of renewable energy generation devices 114 into alternating current (AC) electricity suitable for use, for example, either supplied to an electric grid or to fulfil the captive needs of an individual accessing the renewable energy production source site 118. Each of the one or more inverters 116 may have a data port that is configured to transmit signals comprising the data in digital form and are structured to communicate data including the amount of renewable energy generated by the list of renewable energy generation devices 114, the time (e.g., the time or time duration when the energy is generated), and identification information of the list of renewable energy generation devices 114 and the one or more inverters 116. The one or more inverters 116 may include a self-protection circuitry for self-protection of its electrical circuitry to avoid excess generation of electricity, which avoids any tampering with its DC to AC conversion circuit, thereby maintaining integrity in renewable energy production data.

The renewable energy production source site 118 may correspond to an industrial facility dedicated to generating renewable energy, such as a solar farm, hydropower, large wind turbine facility, and the like, for either captive power consumption or supply the generated renewable energy to a grid (as part of the sale of energy to the grid) for commercial purpose. Other types or scales of the renewable energy generation facilities may also be included.

The registered entity 126 may be an individual or an entity (e.g., an organization) that has ownership of the renewable energy production source site 118. The registered entity 126 may be configured to access information related to the DIGIREC through the user device 128. Examples of the user device 128 may include, but are not limited to, a laptop, a desktop, a smart phone, a tablet, and the like. Through the user device 128, the registered entity 126 may be configured to monitor the overall process of issuing the DIGIREC.

The communication network 130 may include a medium (e.g., a wired or wireless channel) through which each of the central cloud server 102, and the one or more renewable energy metering and monitoring devices 104) and the renewable energy verifier entity 106 via the API 122. Examples of the communication network 130 may include, but are not limited to, the Internet, a cellular network, a Local Area Network (LAN), a wide area network (WAN), a Metropolitan Area Network (MAN), and/or the Internet.

In accordance with an embodiment, the central cloud server 102 is configured to obtain a registration request for the list of renewable energy generation devices 114 and the one or more inverters 116 at the renewable energy production source site 118 from the user device 112 via the front-end interface 112A rendered at the user device 112 and communicatively coupled to the central cloud server 102. The front-end interface 112A rendered at the user device 112 may either be a web-based portal, or an application installed in a user device (e.g. the user device 112), or an interface in communication with at least one of the one or more renewable energy metering and monitoring devices 104. The registration request may include site information related to the renewable energy production source site 118 and device information related to each of the list of renewable energy generation devices 114 and each of the one or more inverters 116. The central cloud server 102 may be configured to process the registration request and extract the site information of the renewable energy production source site 118 and the device information of each of the list of renewable energy generation devices 114 and the one or more inverters 116 received with the registration request.

In an implementation, the central cloud server 102 may trigger a third-party verification to inspect and confirm the site information and the device information for each device at the renewable energy production source site 118 upon receiving the registration request from the user 110 (e.g., the operator). In another implementation, the central cloud server 102 may send a notification or an alert to authorized personnel associated with the central cloud server 102 to visit the renewable energy production source site 118 and install the one or more renewable energy metering and monitoring devices 104 at the renewable energy production source site 118.

In operation, the central cloud server 102 is configured to periodically acquire a plurality of renewable energy production datasets from the renewable energy metering and monitoring device 104A located at the renewable energy production source site 118. The plurality of renewable energy production datasets may include various metrics and parameters depending on an application scenario. For example, the plurality of renewable energy production datasets may include information about the renewable energy sources being utilized (e.g., solar, wind, hydroelectric, biomass, etc.), a time-period over which the renewable energy production is measured (e.g., hourly, daily, monthly, or annually), a geographical location of the renewable energy production source site 118 (e.g., country, region, state, or specific installation site location coordinates), installed capacity of the list of renewable energy generation devices 114 (e.g., kilowatts (kW), megawatts (MW), or gigawatts (GW)), an actual amount of electricity generation capacity by each renewable energy generation device of the list of renewable energy generation devices 114 (usually measured in kilowatts-hours (kWh), megawatt-hours (MWh), or gigawatt-hours (GWh)), information on how renewable energy production is integrated to an electrical grid, including grid stability, balancing, and dispatch, and the like.

In an exemplary implementation, the central cloud server 102 is configured to acquire a digital twin of the renewable energy production source site 118. The digital twin may specify a layout of the renewable energy production source site 118 indicative of various devices, equipment, and their connections and placement in the renewable energy production source site 118.

In accordance with an embodiment, the renewable energy metering and monitoring device 104A at the renewable energy production source site 118 is communicatively coupled to a corresponding data port of the one or more inverters 116 located at the renewable energy production source site 118. In an implementation, the renewable energy metering and monitoring device 104A of the one or more renewable energy metering and monitoring devices 104 may have one or more data ports for communicative coupling to each of the first inverter 116A and the second inverter 116B of the one or more inverters 116. The renewable energy metering and monitoring device 104A may be configured to receive signals from the one or more inverters 116 through the one or more data ports. The signals may include the renewable energy production data. The renewable energy production data may be in a digital format and may include an amount of renewable energy generated by each of the list of renewable energy generation devices 114, a duration of renewable energy generation, and identification information (IDs) corresponding to each of the one or more inverters 116. By establishing the communicative coupling between the renewable energy metering and monitoring device 104A and the one or more inverters 116, the system 100A enables continuous and independent verification of the renewable energy produced at a given installation site. The secured communication between the renewable energy metering and monitoring device 104A and the one or more inverters 116 can be made using wired or wireless communication, or a combination thereof.

The central cloud server 102 is further configured to assign a timestamp and a hash value to each renewable energy production dataset of the plurality of renewable energy production datasets acquired from the renewable energy metering and monitoring device 104A. The timestamp at each renewable energy production dataset may indicate the exact time and duration for which the renewable energy production is measured. The hash value may ensure that the chronology of the acquired renewable energy production dataset is preserved, aiding in traceability and auditability of the plurality of renewable energy production datasets. The hash value may be a unique fixed-size string of characters representing an original data associated with the one or more inverters 116. In an implementation, the hash value may act as a digital fingerprint for each renewable energy production dataset, allowing for verification of the integrity of the plurality of renewable energy production datasets. By assigning the timestamp and the hash value to each renewable energy production dataset, the immutability of each renewable energy production dataset is ensured. This means that once the data is recorded, the data cannot be altered or tampered with easily, providing a reliable and transparent record of renewable energy production. The use of the timestamp and the hash value eliminates the inaccuracies in carbon emission monitoring and facilitates integration with renewable energy certificate markets. Furthermore, if, for any reason, an attempt to tamper or change a recorded renewable energy production data is made, the hash value will change, and thus it can be detected by comparing with previously stored hash value that tampering was done for one or more specific records of renewable energy production data. Thus, the combination of the timestamp and the hash value recorded over a period of time makes the acquired renewable energy production dataset tamper-resilient.

In accordance with an embodiment, the central cloud server 102 is further configured to acquire, from the one or more renewable energy metering and monitoring devices 104 at the renewable energy production source site 118, sensor information indicative of on-the-ground ambient conditions that exist during renewable energy production at the renewable energy production source site 118 influencing production of renewable energy at each renewable energy production source site. The sensor information acquired from the one or more renewable energy metering and monitoring devices 104 may include environmental data, such as temperature, sunlight intensity, wind speed, humidity, air pressure, and other relevant environmental factors in surroundings of the renewable energy production source site 118. The sensor information is collected either continuously or periodically (e.g., every 5 minutes, every hour, or every 2 hours, or a user defined time interval) from the one or more renewable energy metering and monitoring devices 104. The on-the-ground ambient conditions may directly influence the efficiency and output of the list of renewable energy generation devices 114. By continuously analyzing the on-the-ground ambient conditions during renewable energy production, the system 100A provides more accurate, timely and reliable data related to renewable energy generation.

In accordance with an embodiment, an amount of renewable energy produced by the list of renewable energy generation devices 114 at the renewable energy production source site 118 when converted to alternating current (AC) for electricity via the one or more inverters 116 is read directly by the renewable energy metering and monitoring device 104A in a secured device-to-device communication between the renewable energy metering and monitoring device 104A and the one or more inverters 116. The secure device-to-device communication between the renewable energy metering and monitoring device 104A and the one or more inverters 116 ensures the integrity and confidentiality of the renewable energy production data, mitigating the risk of unauthorized access or tampering of the renewable energy production data. In addition, the secure device-to-device communication may facilitate an immediate detection of any discrepancies or anomalies in renewable energy production data, allowing for timely intervention to maintain the renewable energy production at the renewable energy production source site 118.

In accordance with an embodiment, the central cloud server 102 is further configured to form a renewable energy tracking database comprising, for each renewable energy production source site: the plurality of renewable energy production datasets indicative of an amount of renewable energy generated, a date, time and duration when the renewable energy is generated along with supplementary information comprising a location of the renewable energy production source site 118, a fuel type indicative of a type of renewable energy used, an evidence type, and device information of the list of renewable energy generation devices 114 and the one or more inverters 116 registered at the central cloud server 102 for each renewable energy production source site. The formation of the renewable energy tracking database including the amount of renewable energy generated, the duration for which the renewable energy is generated, the location of the renewable energy production source site 118, the fuel type, the evidence type, the device information, and the like, ensures the transparency, reliability and accountability in the system 100A. Additionally, the formation of the renewable energy tracking database prevents data manipulation and mitigate human errors. The renewable energy tracking database may further include generation feedstock representing source or raw material used in generation of the renewable energy. The renewable energy tracking database may also include other business data.

In accordance with an embodiment, the device information comprises two or more of: a unique device identifier of each registered device of the list of renewable energy generation devices 114 and the one or more inverters 116, a unique identifier of the renewable energy metering and monitoring device 104A, a Media Access Control (MAC) or Internet protocol (IP) address of one or more renewable energy metering and monitoring devices 104 at the renewable energy production source site 118, a make and a model of each of the list of renewable energy generation devices 114, or a grid connection status of the renewable energy production source site 118. The system 100A tracks and validates renewable energy produced at installations by obtaining the information from various sources. This information includes the unique device identifier for each registered device, such as the list of renewable energy generation devices 114 and the one or more inverters 116. Such information also includes the unique identifier for the renewable energy metering and monitoring device 104A. Additionally, the system 100A collects the MAC or IP address of the one or more renewable energy metering and monitoring devices 104 at the renewable energy production source site 118. Furthermore, the system 100A captures the make and model of each renewable energy generation device as well as records of the grid connection status of the renewable energy production source site 118. By collecting the device information, the system 100A enables the real-time monitoring and reporting of renewable energy generation. Moreover, the collection of the device information eliminates the reliance on self-reported data and provides continuous independent verification of renewable energy production.

In accordance with an embodiment, the renewable energy tracking database further comprises, for each renewable energy production source site, geographical information of the renewable energy production source site 118 including one or more of: satellite-sensed solar irradiation measurements, weather forecast information, site-specific sensed weather condition information, wind speed information, air temperature information, atmospheric pressure information, air quality or pollution information, relative humidity (RH) information, site-specific rainfall information, precipitable water information, snow days information, CoolingDegree Days (CDDs) information; HeatingDegree Days (HDDs) information, terrain information, or data from local weather stations associated with each renewable energy production source site, and where the central cloud server 102 is further configured to predict an amount of energy loss for a given geographical location of the renewable energy production source site for a given time period and co-relate with the plurality of renewable energy production datasets. The system 100A may be configured to obtain the geographical information for each renewable energy production source site, such as the renewable energy production source site 118. The geographical information is collected through various sources, including but not limited to, the satellite-sensed solar irradiation measurements, weather forecast data, air temperature measurements, atmospheric pressure information, air quality or pollution information, relative humidity (RH) information, terrain information, and data from local weather stations associated with each renewable energy production source site. The increased changes in the climate causes frequent fluctuations in weather that make solar irradiations unpredictable, which directly impacts renewable energy generation. In order to reduce the increased changes in the climate, there is a requirement to measure the ground-level weather-related data, such as air temperature information, atmospheric pressure information, air quality or pollution information, relative humidity (RH) information, site-specific rainfall information, precipitable water information, snow days information, CoolingDegree Days (CDDs) information; HeatingDegree Days (HDDs) information, and the like. Moreover, the tropics, despite having the least number of weather stations, has the most significant negative discrepancy between solar irradiance and solar accuracy. The central cloud server 102 may be configured to address the increased changes in the climate and the negative discrepancy between solar irradiance and solar accuracy in the tropics by considering the measurement of the ground-level weather-related data and including the measured data in the renewable energy tracking database. The system 100A provides authenticated and tamper-resilient renewable energy production data, which is difficult to tamper with. The prediction of the amount of energy loss for the given geographical location of the renewable energy production source site 118 for the given time period and co-relation with the plurality of renewable energy production datasets enhances the integrity and accuracy of renewable energy tracking and verification.

In accordance with an embodiment, the central cloud server 102 is further configured to determine an on-the ground performance for each renewable energy generation device of the list of renewable energy generation devices 114 based on the sensor information indicative of the on-the-ground ambient conditions that exist during renewable energy production at the renewable energy production source site 118. The central cloud server 102 may be configured to determine the efficiency and output of the list of renewable energy generation devices 114 by analyzing the sensor information that provides insights into the prevailing on-the-ground ambient conditions during renewable energy production at the renewable energy production source site 118.

The central cloud server 102 is further configured to generate an electronically verifiable span data package from the plurality of renewable energy production datasets. The central cloud server 102 is further configured to process the electronically verifiable span data package to generate a REC claim request in a defined taxonomy compatible to be read by the API 122 of the first third-party system 120 associated with the renewable energy verifier entity 106.

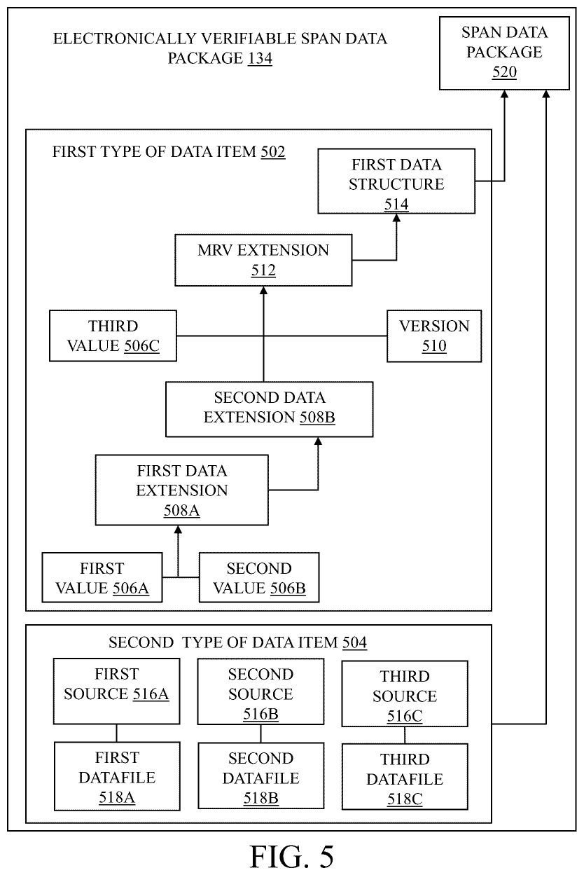

The electronically verifiable span data package may be a corroborating renewable energy production data evidence package. The electronically verifiable span data package may correspond to a specific type of data package collected over a time span, which is tamper-resilient and facilitates to provide evidence of how, when, and where the renewable energy production data was generated and by which device. In an example, the electronically verifiable span data package may have a specific custom designed data structure that may have data associated with the registered sources, such as the list of renewable energy generation devices 114, and the one or more inverters 116 installed at the renewable energy generation source site 104, and other associated evidence information. An example of the electronically verifiable span data package is described in detail, for example, in FIG. 5. The electronically verifiable span data package may be processed to generate the REC claim request. For example, certain information may be extracted from the electronically verifiable span data package to automatically create the REC claim request. For instance, data fields, such as a device code indicative of inverter ID (GIGIES10001—inverter1), a recipient account code (e.g., ETAP92WN) indicative of renewable energy installation site ID or account ID of renewable energy installation, a fuel code (e.g., ES100—Solar) indicative of a type of renewable energy source, a country (e.g., KE—Kenya) indicative of the country of where the renewable energy production occurred, a start date (e.g., 2023 Oct. 9), end date (e.g., 2023 Oct. 11), and period production (e.g., 1.00 MWh) indicative of total renewable energy produced during the start date and the end date. Such data may be extracted from the span data package to generate the REC claim request, for example, claiming the generation of renewable energy of 1 MWh from a solar energy installation located in Kenya over the date range of Oct. 9-11, 2023, in an example. The central cloud server 102 generates the REC claim request in a defined taxonomy suitable to be processed further by the first third-party system 120. The defined taxonomy may serve as a standardized framework for categorizing and organizing the renewable energy production data associated with each of the plurality of renewable energy production datasets. In addition, the defined taxonomy and compatibility of the REC claim request with the API 122 may ensure that the plurality of renewable energy production datasets are seamlessly integrated and accessed by the first third-party system 120 enhancing trust and accountability in the renewable energy market.

In accordance with an embodiment, the electronically verifiable span data package may include a first type of data item comprising REC claim information details, a claim date of the REC claim request, a checkpoint source, a data structure related to the defined taxonomy, a fuel type indicative of a type of renewable energy used, a production capacity of the renewable energy production source site 118, an identifier of the renewable energy production source site 118, and an account information associated with the renewable energy production source site 118 assigned by the renewable energy verifier entity 106. In an implementation, the electronically verifiable span data package may have data from registered sources, which is stored as the evidence for the REC claim request. For instance, the first type of data item may be, for example, a “manifest.json” file, which may comprise the detailed information on the REC claim, the REC claim date, time, generation feedstock, and the taxonomy (i.e., of the relevant REC verifying and issuing entity, for example, taxonomy suited for first third-party system 120) that has been implemented by the renewable energy metering and monitoring device 104A. Additionally, the first type of data item may have the name (i.e., identifier) of the renewable energy production source site 118, fuel type, production capacity and the respective account as assigned by the renewable energy verifier entity 106. The first type of data item is further shown and described in detail, for example, in FIG. 5. By utilizing the REC claim request and the portion of the electronically verifiable span data package, the system 100A ensures continuous independent verification of renewable energy production data to a granular or atomic level, reducing the risk of manipulation and inaccuracies while improving transparency of the renewable energy production. In an example, some information from the first data item of the electronically verifiable span data package may be processed to generate the REC claim request.

In accordance with an embodiment, the electronically verifiable span data package may further include a second type of data item comprising a list of device identities (IDs) and corresponding renewable energy production data associated with each device ID over a specified period as source evidence. In an implementation, the second type of data item may correspond to a source evidence file that may have data related to the renewable energy production over a specific period of time. The list of device identities (IDs) may correspond to unique identities of each of the list of renewable energy generation devices 114, and the one or more inverters 116. The second type of data item is further shown and described, for example, in FIG. 5. By including the list of device identities and energy production data, the system 100A provides a trusted resource for accountability of RECs. In an example, some information from the second data item of the electronically verifiable span data package may be further processed to generate the REC claim request, for example, the start date, the end date, and the device ID of inverter, and total energy generated, etc. The second type of data item may comprise evidence of the renewable energy production over a specific period of time (the start date and end date), which may be communicated or uploaded as additional evidence for verification by the first third-party system 120 along with the REC claim request (e.g., via a UI).

In accordance with an embodiment, after the REC claim request is generated, the central cloud server 102 is further configured to perform pre-validation of the REC claim request prior to communicating the REC claim request to the first third-party system 120 for verification. In the pre-validation, the central cloud server 102 is further configured to execute a local pre-validation of the plurality of renewable energy production datasets acquired from the renewable energy metering and monitoring device 104A using one or more defined checkpoints prior to verification of the REC claim request by the first third-party system 120 associated with the renewable energy verifier entity 106. The local pre-validation of the plurality of renewable energy production datasets may include checking for anomalies, inconsistencies, or errors, if any, in the each of the plurality of renewable energy production datasets. The local pre-validation also includes validating that the renewable energy production data associated with the plurality of renewable energy production datasets meets the pre-defined quality standards and regulatory requirements. The local pre-validation may be done using the one or more defined checkpoints. Each of the one or more defined checkpoints may represent a time bound (including a start time and an end time) energy production as received from each of the one or more renewable energy metering and monitoring devices 104. In addition, each of the one or more defined checkpoints may include a corresponding hash value that confirms the integrity of the renewable energy production data associated with the plurality of renewable energy production datasets. The central cloud server 102 may be configured to apply the one or more (e.g., ‘N’ number) defined checkpoints to ensure the integrity, accuracy, and compliance of the acquired renewable energy production data associated with the plurality of renewable energy production datasets. In an example, a checkpoint may be applied for a defined duration, for example, 2 hours, during which the renewable energy metering and monitoring device 104A acquires the renewable energy production data from the one or more inverters 116. On execution of the local pre-validation of the plurality of renewable energy production datasets, the central cloud server 102 may be configured to trigger and communicate the REC claim request to the first third-party system 120. The local pre-validation of the plurality of renewable energy production datasets may proactively minimize the risk of errors or discrepancies in the REC claims, further enhancing the credibility and transparency of the system 100A.

The central cloud server 102 is further configured to communicate the generated REC claim request along with a portion of the electronically verifiable span data package as evidence to the first third-party system 120. The portion of the electronically verifiable span data package may be the second data item (e.g., the source evidence file) providing evidence of renewable energy production specific to what is claimed in the REC claim request. The REC claim request may provide the details of the source of the renewable energy and time period of the renewable energy generation to the first third-party system 120 (i.e., a registry system) that, in response, verifies the REC claim request and causes the REC issuing entity 108 to issue a digital certificate, such as an International Renewable Energy Certificate from Electricity (“I-REC (E)”) under the stringent taxonomy regulations adopted for use in the standards for issuing I-RECs. The REC claim may be an assertion for an amount of renewable energy associated with the portion of the electronically verifiable span data package generated at the renewable energy production source site 118. The REC claim request may be generated and triggered by the central cloud server 102 to initiate the issuance of the REC corresponding to the portion of the electronically verifiable span data package that indicates and validates the renewable energy production data acquired from the renewable energy metering and monitoring device 104A. Post generation of the REC claim request, the pre-validation may occur, followed by communication of the REC claim request along with the portion of the electronically verifiable span data package as evidence to the first third-party system 120. The first third-party system 120 then verifies the renewable energy production data using the portion of the electronically verifiable span data package.

In accordance with an embodiment, the generation of the REC claim request is triggered when the plurality of renewable energy production datasets periodically acquired from the renewable energy metering and monitoring device 104A indicates that an individual inverter of the one or more inverters 116 has generated a defined amount of renewable energy equal to or greater than a threshold amount or a defined amount of time of renewable energy equal to or greater than a threshold amount. For instance, if either the first inverter 116A or the second inverter 116B of the one or more inverters 116 has generated the defined amount of renewable energy equal to or greater than the threshold amount (e.g., a 1000 kilowatt hours=1 MWh of renewable energy up to, for example, six decimal places, with below megawatt hour resolution to the watt-hour (Wh) optional) or when the duration of renewable energy generation equals or exceeds the defined threshold amount of time then, the central cloud server 102 may be configured to trigger the REC claim request. The central cloud server 102 may be configured to trigger one REC claim request on the generation of one MWh of renewable energy.

In accordance with an embodiment, the generation of the REC claim request may be triggered when the plurality of renewable energy production datasets periodically acquired from the renewable energy metering and monitoring device 104A indicates that the one or more inverters 116 collectively at the renewable energy production source site 118 has generated a defined amount of renewable energy equal to or greater than a threshold amount or a defined amount of time of renewable energy equal to or greater than a threshold amount. For instance, if the one or more inverters 116 collectively has generated the defined amount of renewable energy equal to or greater than the threshold amount (e.g., one Megawatt-hour (MWh)) then the central cloud server 102 may be configured to trigger the REC claim request. By automating the triggering of the REC claim requests based on specific thresholds, the system 100A ensures a more reliable and accountable resource for RECs.

The central cloud server 102 is further configured to acquire, from the first third-party system 120, a unique identifier of a first REC associated with the REC issuing entity 108 when the REC claim request is successfully verified. The unique identifier associated with the first REC ensures the uniqueness of the first REC. The first REC serves as a proof that a certain quantity of electricity (typically 1 one Megawatt-hour (MWh)) is generated using the list of renewable energy generation devices 114 at the renewable energy generation source site 104. Moreover, the issuance of the first REC enables the tracking and verification of renewable energy production for regulatory compliance and voluntary sustainability initiatives. Typically, the first REC may be non-interactive (e.g., a portable document format), having the name of the registered entity, such as the registered entity 126, the physical location of the renewable energy generation source site 104, country name, units of electricity generated using the renewable energy, type of renewable energy generated, how much reduction in carbon emission is achieved through the renewable energy generation, and the like. The acquiring of the unique identifier associated with the first REC may ensure that the renewable energy produced at the renewable energy production source site 118 is officially recognized and may be traded or used to meet the renewable energy goals. The acquiring of the unique identifier associated with the first REC from the first third-party system 120 enhances the accountability and transparency of the REC issuing process.

The central cloud server 102 is further configured to generate an interactive digital renewable energy certificate (DIGIREC) asset based on predefined REC-taxonomy metadata and the acquired unique identifier, where the interactive DIGIREC asset is associated with an ownership to the registered entity 126 of the renewable energy production source site 118. The interactive DIGIREC asset may be defined as a digital exchangeable energy attribute certificate-based asset that assures authenticity and provenance about the production of a unit of electricity through renewable energy through an objective digital evidence chain of custody based on a multi-layered verification of renewable energy production corresponding to the plurality of renewable energy production datasets. This is not possible with the first REC issued by the REC issuing entity 108. The term “interactive” is indicative of the capability bestowed on users, who can click on or interact with the interactive DIGIREC asset to be assured at a granular level (or atomic level) about the authenticity and provenance of renewable energy production claimed in the interactive DIGIREC asset. The interactive DIGIREC asset is different from the first REC, at least in a renewable energy production provenance function associated with the interactive DIGIREC asset. The renewable energy production provenance function allows us to authenticate and prove the production of the unit of electricity using renewable sources using the interactive DIGIREC asset. The interactive DIGIREC asset generated based on predefined REC-taxonomy metadata and the acquired unique identifier of the first REC is an absolute, automated, digital, climate-based tradeable financial asset that provides beneficiaries (such as the registered entity 126) real-time transparency to verify the authenticity and provenance of each renewable energy certificate issued per megawatt hour (MWh) up to the power generation source of electricity including but not limited to, solar, wind, hydro, geothermal, nuclear, hydrogen, and biofuels. The interactive DIGIREC asset provides information of the renewable energy production data at an atomic level including numerous metadata points unique to each production plant, but not limited to geographic location, weather, production time, and other insights provide accurate third-party assurance to fulfil global regulatory requirements, including but not limited to, the US State of California's SB253 Climate Corporate Data Accountability Act and SB261 Greenhouse Gases: Climate-Related Financial Risk requirements. The interactive DIGIREC asset also provides complete transparency to independently verify the authenticity and provenance of each certificate down to plant-level GPS coordinates, as well as unbiased verification of the underlying production data that confirms the foundational relevance for the interactive DIGIREC asset based on the IREC standard foundation taxonomy. The interactive DIGIREC asset can also be traded via market exchanges to scale its adoption so that organizations can achieve net zero goals based on electricity. Moreover, the interactive DIGIREC asset eliminates the challenges limiting the global markets for primary issuance and secondary trading of over-the-counter (OTC) transactions, including double-counting, pricing transparency, untrusted and unverifiable certificates, and automation trading to support Power Purchase Agreements. The interactive DIGIREC asset may also be referred to as a Digital International Renewable Energy Certificate (DIGIREC) for Electricity.

By transitioning to the digital and self-verifiable capability of the interactive DIGIREC asset, the system 100A enables continuous independent monitoring, verification, and validation of the renewable energy production data. It reduces the chances for manipulation of the reported data. Furthermore, the system 100A may establish a transparent chain of custody (ownerships by different entities or users) for the interactive DIGIREC asset, enhancing accountability and transparency in renewable energy transactions and ensuring that the value derived from the renewable energy production accrues to the rightful owner. In other words, the system 100A may keep a clear record of who owns the interactive DIGIREC asset at any given time and how they are transferred between various registered entities.

In accordance with an embodiment, the central cloud server 102 is further configured to embed ancillary information in an encrypted form in the interactive DIGIREC asset, and where the ancillary information comprises a production location, a production date and timestamp indicative of where and when the interactive DIGIREC asset and related unit of renewable energy is produced. The embedding of the ancillary information in the encrypted form in the interactive DIGIREC asset provides transparent evidence of where and when the interactive DIGIREC asset and its related unit of renewable energy is produced. The encryption of the ancillary information may ensure that any sensitive data related to the interactive DIGIREC asset's production is protected from any unauthorized access or tampering, thus maintaining the integrity and confidentiality of the information.

In accordance with an embodiment, the central cloud server 102 is further configured to track a redeemed status of the interactive DIGIREC asset based on one or both of: a confirmation from an electronic renewable energy exchange platform that indicates a successful redemption or an expiry of a defined validity period and tagging the interactive DIGIREC asset as no longer available at the central cloud server 102 or the renewable energy exchange platform for further use after receiving the confirmation of the successful redemption or after the expiry of the defined validity period. The central cloud server 102 may be configured to monitor the status of the interactive DIGIREC asset to determine whether the interactive DIGIREC asset is either redeemed or expired. The confirmation from the electronic renewable energy exchange platform (e.g., an online portal of the relevant REC issuing entity) may indicate whether the interactive DIGIREC asset has been successfully redeemed or not. In an exemplary implementation, the interactive DIGIREC asset may have a defined validity period (e.g. the validity period may be checked and verified with the relevant REC issuing entity), after which it may expire. In another implementation, the interactive DIGIREC asset may not have a validity period or a long-term validity (say 10 years) in some jurisdictions, depending on local laws related to renewable energy certificates. The central cloud server 102 may be configured to set, remove, or extend the validity period in accordance with local, or country-specific or global-standard-specific laws or rules associated with RECs. The central cloud server 102 may be configured to track the expiry of the interactive DIGIREC asset based on the defined validity period (when present). The central cloud server 102 may be configured to maintain an up-to-date record of available certificates, facilitating transparency and trust in the certification process by monitoring the interactive DIGIREC asset for successful redemption or expiry. The interactive DIGIREC asset can be used in a trading exchange to offset, for example, minute-level carbon emissions by the buyer (by redeeming the interactive DIGIREC asset).

In accordance with an embodiment, the tagging of the interactive DIGIREC asset may ensure that redeemed or DIGIRECs with no validity period cannot be reused or issued again respectively, thereby preventing double counting or fraudulent activities. The central cloud server 102, may be configured to receive the identification of the interactive DIGIREC asset and to update the database records to show that the interactive DIGIREC asset is used within the allotted time period (and would block the redemption of expired or previously redeemed certificates (i.e., DIGIREC)). The real time update of the redeemed certificates (i.e., DIGIREC) prevents unauthorized uses and ensures transparency and reliability in the system 100A. The registry can be updated to reflect the redeemed certificate and the associated data.

In accordance with an embodiment, the central cloud server 102 is further configured to generate an audit trail accessible remotely via an audit user interface (UI) to allow a remote or on-site auditing by an authorized auditor to prove one or more renewable energy certificate (REC) claims, and where the audit trail is generated based on the plurality of renewable energy production datasets acquired periodically from the renewable energy metering and monitoring device 104A located at the renewable energy production source site 118. The audit trail is accessible remotely through the audit UI. The authorized auditor can use this interface to conduct either remote or on-site auditing. The audit trail may include a detailed chronological record of activities related to renewable energy production and the REC claims. The audit trail may include information such as timestamps, renewable energy production data, REC claim requests, verification outcomes, and any other relevant information related to the interactive DIGIREC asset issuance and verification processes. The authorized auditor may be any authorized individual or entity responsible for verifying the accuracy and validity of the REC claims and may access the audit trail to confirm various aspects of renewable energy production and REC transactions over a period. For example, as the detailed chronological record of activities related to the renewable energy production and the REC claims is stored in the central cloud server 102, beneficially, such renewable energy production activities may be accessed a year or many years later after the DIGIREC has issued. Thus, there may be a long audit trail to verify the accuracy of the information (e.g., even 10 years later). The authorized auditor may access the audit trail from any place with availability of internet access.

In accordance with an embodiment, the audit trail may be generated further based on local sensor data that influence production of renewable energy at each renewable energy production source site obtained from the one or more renewable energy metering and monitoring devices 104 at the renewable energy production source site 118. The local sensor data may include information about weather conditions, solar irradiance levels, temperature or any other factors affecting renewable energy production. The generation of the audit trail based on local sensor data leads to the improvement in the integrity and accuracy of tracking, validation, and verification of renewable energy production.

In accordance with an embodiment, the central cloud server 102 is further configured to calculate an amount of green and clean electricity achieved from a total amount of renewable energy verifiably produced over a defined period at the renewable energy production source site 118, based on a tracking of the plurality of renewable energy production datasets acquired from the one or more renewable energy metering and monitoring devices 104 and generate a verifiable green and clean electricity report based on the calculated amount of DIGIRECs produced, where the verifiable green and clean electricity report is accessible for independent third-party verification. The calculation of the amount of green and clean electricity may include computing the reduction in carbon emissions resulting from the generation of renewable energy compared to traditional fossil fuel-based energy sources. The verifiable green and clean electricity report may include detailed information on the calculated amount of DIGIRECs produced, along with relevant data such as the time period covered, methodology used for calculation, and any other pertinent details required for verification. The calculation of the amount of green and clean electricity may assess the impact of environmental factors on renewable energy production and allow stakeholders to quantify the reduction in greenhouse gas emissions attributable to renewable energy generation. Furthermore, the central cloud server 102 may provide access to the green and clean electricity report for independent third-party verification which may enhance credibility and trust in the reported green and clean electricity outcomes. The third-party verification may add an extra layer of assurance regarding the accuracy and reliability of the reported data. Also, the access to the green and clean electricity report for independent verification may foster transparency and accountability, supporting trust-building efforts among stakeholders, including investors, regulators, and the public. Moreover, the system 100A contributes to the formation and scaling of energy attribute certificates, promoting more accurate and reliable monitoring of the green and clean electricity resulting reduction of negative climate change impacts.

FIG. 1B is a diagram illustrating interoperability of various components of a system of immutable electronic processing of renewable energy production data for issuing DIGIRECs for electricity, in accordance with an embodiment of the present disclosure. FIG. 1B is described in conjunction with elements of FIG. 1A. With reference to FIG. 1B, there is shown a system 100B that may include the central cloud server 102, the first inverter 116A, and the renewable energy metering and monitoring device 104A of the one or more renewable energy metering and monitoring devices 104, the first-third party system 120 associated with the renewable energy verifier entity 106, the second-third party system 124 associated with the REC issuing entity 108. There is further shown a digital automated claims builder 132 in the central cloud server 102, an electronically verifiable span data package 134, a first database 136 associated with the central cloud server 102, a REC claim request 138, a processed REC claim 140, a second database 142 associated with the renewable energy verifier entity 106, an interactive DIGIREC asset 144 and a verification contract 146. There is further shown a sequence of operations 148 to 160, and 164. The system 100B corresponds to the system 100A of FIG. 1A). There is further shown a digital automated claims verifier 162.

The digital automated claims builder 132 may also be referred to as a digital claims' builder. In an implementation, the digital automated claims builder 132 may be a part of or may also be referred to as a project application, which may be installed at the central cloud server 102. The digital automated claims builder 132 may be configured to receive the renewable energy production data from the renewable energy metering and monitoring device 104A.

Examples of the digital automated claims builder 132 must be realized on a tamper-resilient data platform, which may be implemented using different available technologies. Such technology options may include, but are not limited to, known non-distributed ledger technology, enterprise data infrastructure or distributed ledger technology (DLT) systems that can include, but are not limited to, distributed ledger based renewable energy management software, renewable energy platforms, cloud-based energy analytics platform, and the like.

In an implementation scenario of the system 100B, the renewable energy metering and monitoring device 104A and the first inverter 116A may be installed at the renewable energy production source site 118. The renewable energy metering and monitoring device 104A may be configured to receive a plurality of signals from the first inverter 116A. The plurality of signals may communicate the renewable energy production data associated with the first inverter 116A to the renewable energy metering and monitoring device 104A. The communication between the renewable energy metering and monitoring device 104A and the first inverter 116A may be either wired, or wireless, or a combination thereof.

Initially, the central cloud server 102 may be configured to obtain a registration request from the user device 112 (not shown in FIG. 1B) to register each of the list of renewable energy generation devices 114 and each of the one or more inverters 116 installed at the renewable energy generation source site 104 via the front-end interface 112A rendered at the user device 112 (of FIG. 1A; not shown in FIG. 1B). In case, if any of the list of renewable energy generation devices 114 or any of the one or more inverters 116 is upgraded or replaced, then the upgrade information may also be synchronized with the central cloud server 102 through the front-end interface 112A rendered at the user device 112. The digital automated claims builder 132 may be configured to periodically acquire a plurality of renewable energy production datasets from the renewable energy metering and monitoring device 104A through an API, for example, a web application.

At operation 148, each of the list of renewable energy generation devices 114 may be configured for renewable energy generation at the renewable energy production source site 118 and each of the one or more inverters 116 may be configured for conversion from DC to AC form of electricity and communicate the converted AC energy to the renewable energy metering and monitoring device 104A from where the converted AC energy may be read by the renewable energy metering and monitoring device 104A installed at the renewable energy production source site 118. Each of the one or more inverters 116 at the renewable energy production source site 118 may be configured for DC to AC conversion either on an hourly basis, daily basis or monthly basis, depending on the requirement. The digital automated claims builder 132 at the central cloud server 102 may be configured to continuously read the renewable energy production data from the renewable energy metering and monitoring device 104A. Additionally, the digital automated claims builder 132 (e.g., the project application) may be configured to continuously read sensor information indicative of on-the-ground ambient conditions that exist during renewable energy production at the renewable energy production source site 118 influencing the production of renewable energy at each renewable energy production source site from the renewable energy metering and monitoring device 104A. After reading the renewable energy production data from the renewable energy metering and monitoring device 104A, the digital automated claims builder 132 may further be configured to generate one or more checkpoints and the electronically verifiable span data package 134 by assigning a timestamp and a hash value to each renewable energy production dataset of the plurality of renewable energy production datasets. The electronically verifiable span data package 134 corresponds to a tamper-resilient data package, a portion of which may be used as evidence. Alternatively stated, the digital automated claims builder 132 may be configured to perform continuous evidence collection and packaging (i.e., continuously reading the renewable energy production data from the renewable energy metering and monitoring device 104A and generating the electronically verifiable span data package 134 stored in the central cloud server 102. A portion of the electronically verifiable span data package 134 is used as evidence and communicated to the first third-party system 120, not the entire electronically verifiable span data package 134, which remains stored in the central cloud server 102. In other words, evidence information pertaining to an evidence file that provides evidence of the renewable energy production in a span of time claimed in the REC claim request may be extracted as the portion from the electronically verifiable span data package 134 and communicated to the first third-party system 120. In an implementation, the electronically verifiable span data package 134 may include one or more checkpoints, where one checkpoint may represent the renewable energy production in a span of time, including the start time, end time, and date of energy production. The checkpoint also includes a corresponding hash value assigned to each renewable energy production dataset that confirms the integrity of the renewable energy production dataset.

At operation 150, the digital automated claims verifier 162 may be configured to process the electronically verifiable span data package 134 to generate the REC claim request 138. At operation 152, the digital automated claims verifier 162 may be configured to execute a local pre-validation of the REC claim request 138 for the plurality of renewable energy production datasets acquired from the renewable energy metering and monitoring device 104A using the one or more defined checkpoints comprised in the electronically verifiable span data package 134. The operation 152 may include one or more sub-operations, such as operations 154, 156, 158, and 160. During local pre-validation, the electronically verifiable span data package 134 may temporarily be stored in the first database 136 associated with the central cloud server 102. At operation 154, the one or more checkpoints comprised in the electronically verifiable span data package 134 are processed and pre-validated. At operation 156, the pre-validated checkpoints are collected and the REC claim request 138 is validated and prepared for communication to the first third-party system 120. The renewable energy verifier entity 106 may also be referred to as a verifying body (VB). In an implementation, the API 122 through which the digital automated claims verifier 162 communicates with the first-third party system 120 may be referred to as a verification service. The verification service may be configured to perform verification of the REC claim request 140 (post the local pre-validation) communicated by the digital automated claims verifier 162. At operation 158, the digital automated claims verifier 162 (i.e., a part of the central cloud server 102) may be configured to compute the estimated MWh of electricity contained in the one or more checkpoints. At operation 160, the digital automated claims verifier 162 may be configured to collect the verified checkpoints and generate the processed REC claim request 140 (processed and pre-validated REC claim request) in a predefined REC-taxonomy metadata. The processed REC claim request 140 may also be stored in a database within the central cloud server 102. In an implementation, the electronically verifiable span data package 134 and the one or more checkpoints may be stored in a database, namely Environmental Credit Service (ECS), accessible at the central cloud server 102. The processed REC claim request 140 corresponds to the REC claim request after pre-validation by the digital automated claims verifier 162. At this stage, after local pre-validation is complete, the REC claim request 138 may also be referred to as a processed REC claim request 140 (or simply referred to as a processed REC claim). After pre-validation, the registry adapter may be configured to communicate a REC (an asset) issuance request to the first third-party system 120. In an implementation, the registry adapter may also be referred to as an API (e.g., the API 122 of FIG. 1A), which through the first-third party system 120 communicates with the central cloud server 102. In other words, at operation 164, the digital automated claims verifier 162 may be configured to communicate the processed REC claim request 140 (e.g., an environmental REC claim) to the first-third party system 120 through the API 122 along with a portion of the electronically verifiable span data package 134 as evidence. Upon successful verification by the first third-party system 120, the digital automated claims verifier 162 may be configured to acquire a unique identifier from the first third-party system 120 of a first REC. The first REC may be associated with the REC issuing entity 108. In response to the acquired unique identifier, the digital automated claims verifier 162 may be configured to generate the interactive DIGIREC asset 144 (has been described in detail, for example, in FIG. 1A) based on predefined REC-taxonomy metadata and the acquired unique identifier. The interactive DIGIREC asset 144 is associated with ownership to the registered entity 126 of the renewable energy production source site 118. The interactive DIGIREC asset 144 may be used in a trading exchange with one or more buyers based on the offset for multiple carbon emissions. The interactive DIGIREC asset 144 may be referred to as transferrable proof for the generation of one MWh of electricity from renewable energy sources. The interactive DIGIREC asset 144 permits its buyer to claim consumption of one MWh of renewable energy. The interactive DIGIREC asset 144 is generated based on predefined REC-taxonomy metadata to confirm the buyer's ability to reach Net Zero on Electricity (NZoE) targets.

In addition, the interactive DIGIREC asset 144 may be assigned to the registered entity 126 (i.e., owner) of the renewable energy production source site 118 (of FIG. 1A) which may be benefitted of all the legal rights associated with the renewable energy production, as certified by the interactive DIGIREC asset 144. The system 100B may establish a clear chain of custody for the interactive DIGIREC asset 144, enhancing accountability and transparency in renewable energy transactions and ensuring that the value derived from the renewable energy production accrues to the rightful owner. In other words, the system 100B may keep a clear record of who owns the interactive DIGIREC asset 144 at any given time and how they are transferred between one or more registered entities.

In an exemplary implementation, the system 100B may include the verification contract 146, which may be a type of smart contract that records and governs the interactions and data flows between the different parties involved in the REC issuance process, for example, the central cloud server 102 and the first third-party system 120 of the renewable energy verifier entity 106. Specifically, the verification smart contract codifies and records the cadence or schedule at which the central cloud server 102 may submit requests for pre-validation of its renewable energy production to the digital automated claims verifier 162, the provision of the pre-validated claims/data from the digital automated claims verifier 162 back to the central cloud server 102, and the issuance of the REC based on the verified data, and further generation of the interactive DIGIREC asset 144. Recording these interactions on a digital registry or a digital platform via the smart contract enables automation and adds transparency to the full cycle of renewable energy verification and REC issuance. Thus, the verification contract 146 is a time-stamped smart contract that orchestrates and records the key steps and data handoffs between the producer, verifier, and issuer to streamline and automate the DIGIREC issuance workflow.

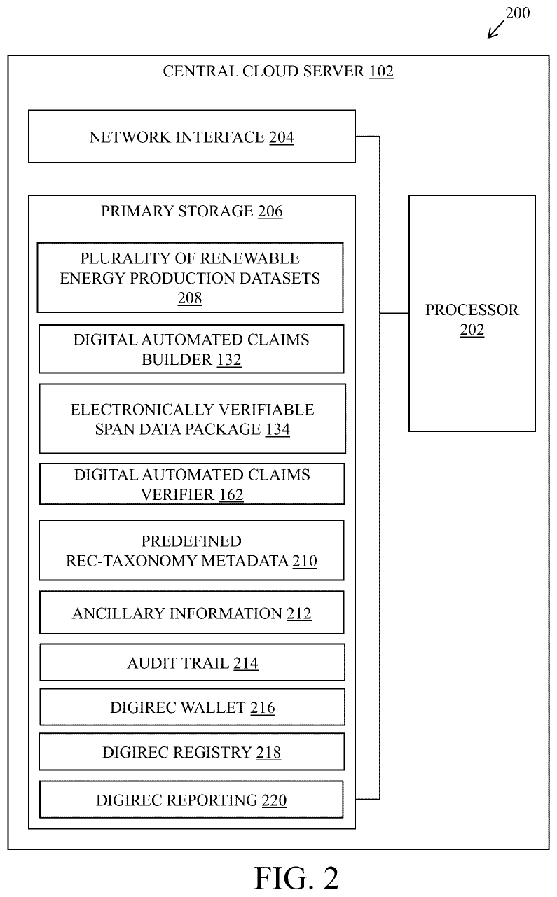

FIG. 2 is a diagram illustrating various exemplary components of a central cloud server, in accordance with an embodiment of the present disclosure. FIG. 2 is described in conjunction with the elements of FIGS. 1A and 1B. With reference to FIG. 2, there is shown a block diagram 200 of the central cloud server 102 that may include a processor 202, a network interface 204, and a primary storage 206. The primary storage 206 may store the digital automated claims builder 132, the electronically verifiable span data package 134, a plurality of renewable energy production datasets 208, a digital automated claims verifier 162, predefined REC taxonomy metadata 210, ancillary information 212, an audit trail 214, a DIGIREC wallet 216, a DIGIREC registry 218 and a DIGIREC reporting 220. Each of the processor 202, the network interface 204 and the primary storage 206 are communicatively coupled to each other.

The processor 202 may include suitable logic, circuitry, interfaces and/or code that may be configured to execute instructions stored in the primary storage 206. Examples of the processor 202 may include, but are not limited to, an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the processor 202 may refer to one or more individual processors, processing devices, or a processing unit that is part of a machine. The processor 202 of the central cloud server 102 may be configured to execute each and every function, which is executed by the central cloud server 102 for issuance of the interactive DIGIREC asset 144.

The network interface 204 may include suitable logic, circuitry, and/or interface that is configured to receive the plurality of renewable energy production datasets 208 from the renewable energy metering and monitoring device 104A (of FIG. 1A). The network interface 204 enables the central cloud server 102 to communicate with the various entities of the system 100A including the renewable energy production source site 118, and the REC issuing entity 108 through the communication network 130.

The primary storage 206 may include suitable logic, circuitry, interfaces and/or code that is configured to store machine code and/or instructions executable by the processor 202. The primary storage 206 may be configured to store the amount or unit of electricity (may be a fractional unit) generated by the renewable energy production source site 118 using the list of the renewable energy generation devices 114 and the one or more inverters 116 and related information including time and location where the renewable energy is generated. The stored information may be used for verification based on time and date at a granular level, such as minutes or seconds, in association with the amount of energy generated. Examples of implementation of the primary storage 206 may include, but are not limited to, an Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory. The primary storage 206 may store an operating system and/or a computer program product to operate the central cloud server 102. Moreover, the information stored in the primary storage 206 can be backed up to a secondary storage (not shown here for sake of brevity) periodically for fail-safe retrieval of data to mitigate any unforeseen events, such as a hardware or software a crash of the renewable energy metering and monitoring device 104A.

The digital automated claims builder 132, the electronically verifiable span data package 134, the plurality of renewable energy production datasets 208 and the digital automated claims verifier 162 have been described in detail, for example, in FIGS. 1B, 1A-1B, 1A, and 1B, respectively.

The predefined REC-taxonomy metadata 210 may refer to standardized requirements, which are predefined and designed to facilitate the organization, retrieval and analysis of information related to the interactive DIGIREC asset 144. The predefined REC-taxonomy metadata 210 may also be referred to as a predefined renewable energy verifier entity taxonomy metadata.

The ancillary information 212 comprises a production location, a production date and a timestamp indicative of where and when the interactive DIGIREC asset 144 and related unit of renewable energy is produced. The ancillary information 212 may be referred to as supplementary or additional information, data or context that supports the automated issuance process of the interactive DIGIREC asset 144. The ancillary information 212 may include supporting documents, footnotes, metadata, or any other relevant details that enhance understanding or provide additional context related to the interactive DIGIREC asset 144.

The audit trail 214 may be accessible remotely via an audit user interface (UI) to allow remote or on-site auditing by an authorized auditor to prove one or more renewable energy certificate (REC) claims. The audit trail 214 is generated based on the plurality of renewable energy production datasets 208 acquired periodically from the renewable energy metering and monitoring device 104A located at the renewable energy production source site 118.

The DIGIREC wallet 216 may be referred to as a software-based system that may be configured to securely store the trading information (including payment methods, websites, passwords, and the like) of the interactive DIGIREC asset 144. By use of the DIGIREC wallet 216, the buyers of the interactive DIGIREC asset 144 can make electronic commercial transactions quickly and securely.

The DIGIREC registry 218 may be referred to as a record-keeping system that may be configured to store all the information related to the interactive DIGIREC asset 144, such as when, and where the interactive DIGIREC asset 144 is generated and traded between various registered entities and for what time duration. The DIGIREC registry 218 may provide a centralized, searchable and secure storage of information related to the interactive DIGIREC asset 144 and enhance data accessibility of the interactive DIGIREC asset 144.

The DIGIREC reporting 220 may be referred to as the process of creating, distributing and consuming reports related to the interactive DIGIREC asset 144 in a digital format. The DIGIREC reporting 220 may replace traditional paper-based reporting methods with electronic formats and allows an improves efficiency, accessibility and interactivity. The DIGIREC reporting 220 may encompass various types of reports, such as renewable energy production data, trading reports of the interactive DIGIREC asset 144, and the like.

The processor 202 of the central cloud server 102 may be configured to periodically acquire the plurality of renewable energy production datasets 208 from the renewable energy metering and monitoring device 104A. In addition, the processor 202 of the central cloud server 102 may be configured to assign the timestamp and the hash value to each renewable energy production dataset of the list of renewable energy production datasets 208. Further, the processor 202 of the central cloud server 102 may be configured to generate the electronically verifiable span data package 134 by assigning a timestamp and a hash value to each of the plurality of renewable energy production datasets 208. The electronically verifiable span data package 134 is then processed to generate a REC claim (referred to as a REC claim request). The REC claim request is generated in a defined taxonomy compatible to be read by the API 122 of the first third-party system 120 associated with the renewable energy verifier entity 106. The processor 202 may be further configured to execute pre-validation of the REC claim request. In other words, the processor 202 may be further configured to execute a local pre-validation of the plurality of renewable energy production datasets 208 acquired from the renewable energy metering and monitoring device 104A using one or more defined checkpoints prior to verification of the REC claim request by the first third-party system 120. Thereafter, the processor 202 may be further configured to communicate the REC claim request to the first third-party system 120 along with a portion of the electronically verifiable span data package 134 as evidence. On successful verification of the REC claim request, the processor 202 may further be configured to acquire a unique identifier associated with a first REC from the first third-party system 120. The first REC may be issued by the REC issuing entity 108, but the first third-party system 120 facilitates and communicates back the information to the central cloud sever 102 related to the first REC, such as the unique identifier associated with the first REC. The processor 202 may further be configured to generate the interactive DIGIREC asset 144 based on the predefined REC-taxonomy metadata 210 and the acquired unique identifier, where the interactive DIGIREC asset 144 is associated with an ownership to the registered entity 126 of the renewable energy production source site 118.

In addition, the processor 202 may be configured to track a redeemed status of the interactive DIGIREC asset 144 based on one or both of: a confirmation from an electronic renewable energy exchange platform that indicates a successful redemption or an expiry of a defined validity period. Further, the processor 202 of the central cloud server 102 may be configured to tag the interactive DIGIREC asset 144 as no longer available at the central cloud server 102 or the renewable energy exchange platform for further use after receiving the confirmation of the successful redemption or after the expiry of the defined validity period. The processor 202 may be configured to embed the ancillary information 212 in an encrypted form in the interactive DIGIREC asset 144.

FIG. 3 is a diagram illustrating various exemplary components of a renewable energy metering and monitoring device, in accordance with an embodiment of the present disclosure. FIG. 3 is described in conjunction with the elements of FIGS. 1A, 1B, and 2. With reference to FIG. 3, there is shown a block diagram 300 of the renewable energy metering and monitoring device 104A that may include a network interface 302, a data acquisition circuit 304, a meter 306, a sensor circuit board 308 and a controller 310.

The network interface 302 may include suitable logic, circuitry, and/or interfaces that is configured to establish a communication channel with the one or more inverters 116 at the renewable energy production source site 118.

The data acquisition circuit 304 may be configured to acquire raw renewable energy production data as electricity is generated from one or more renewable energy generation devices at the renewable energy production source site 118 based on data signals directly obtained from the one or more inverters 116 over the established communication channel. The data acquisition circuit 304 enables monitoring of renewable energy generation. The data acquisition circuit 304 may be configured to proactively detect any fluctuations in the renewable energy production.

The meter 306 may be a smart meter configured to monitor and record the amount of renewable energy generated, along with the date and duration of renewable energy generation. The meter 306 may also be referred to as a smart electrical meter. The meter 306 and the data acquisition circuit 304 are connected in a transmission line with the AC electricity produced and transmitted by the one or more inverters 116. The meter 306 may be configured to measure the electricity in a live fashion as it is generated and passes through the transmission line. In some configurations, if the arrangement is such that the locally generated electricity is used by the same facility (i.e., the renewable energy production source site 118) before being transmitted to an electrical grid (captive needs), still the meter 306 may read and capture the electricity generated. The meter 306 may ensure the accuracy and reliability of the renewable energy production data by directly monitoring the AC electricity produced by the one or more inverters 116.

The sensor circuit board 308 may include one or more sensors configured to generate sensor information indicative of on-the-ground ambient conditions that exist during renewable energy production at the renewable energy production source site 118 influencing production of renewable energy. Examples of the one or more sensors may include, but are not limited to, weather sensors, air quality sensors, wind speed sensors, air temperature sensors, connection status sensors, and the like.

The controller 310 may be configured to communicate the plurality of renewable energy production datasets 208 to the central cloud server 102 where they are processed for verification and issuance of the interactive DIGIREC asset 144. Examples of the controller 310 may include, but are not limited to, a processor, an integrated circuit, a co-processor, a microprocessor, a microcontroller, a complex instruction set computing (CISC) processor, an application-specific integrated circuit (ASIC) processor, a reduced instruction set (RISC) processor, a very long instruction word (VLIW) processor, a central processing unit (CPU), a state machine, a data processing unit, and other processors or circuits. Moreover, the controller 310 may refer to one or more individual processors, processing devices, a processing unit that is part of a machine.

In operation, the network interface 302 of the renewable energy metering and monitoring device 104A may be configured to establish the communication channel with the one or more inverters 116 at the renewable energy production source site 118. By virtue of the network interface 302, the renewable energy metering and monitoring device 104A manifests the ability to communicate with the one or more inverters 116, installed at the renewable energy production source site 118, in order to receive, monitor and track the AC energy produced by the one or more inverters 116. In an implementation, each of the one or more inverters 116 may have a digital port to provide live continuous energy production information and related data to the renewable energy metering and monitoring device 104A. Moreover, the renewable energy metering and monitoring device 104A may be configured to be adapted to the renewable energy production data received from the one or more inverters 116 if the one or more 116 are configured to provide the data periodically. The data acquisition circuit 304 may be configured to acquire raw renewable energy production data as electricity is generated from the list of renewable energy generation devices 114 at the renewable energy production source site 118 based on data signals directly obtained from the one or more inverters 116 over the established communication channel. The data signals may include information, such as the amount of renewable energy generated, the time-period of renewable energy generation, and identification details of the location of the one or more inverters 116. Thereafter, the data acquisition circuit 304 of the renewable energy metering and monitoring device 104A may be configured to read the acquired raw renewable energy production data as and when electricity is generated from the list of renewable energy generation devices 114 at the renewable energy production source site 118. The data acquisition circuit 304 may be configured to read the raw renewable energy production data in real-time based on data signals directly obtained from the one or more inverters 116 over the established communication channel. The real-time reading of the raw renewable energy production data enables the renewable energy metering and monitoring device 104A to proactively detect and respond to any fluctuations in renewable energy production.

Furthermore, the meter 306 of the renewable energy metering and monitoring device 104A may be configured to monitor and record an amount of renewable energy generated as well as a date and a duration for which the renewable energy is generated. By monitoring and recording the amount of renewable energy generated, the meter 306 may ensure the accuracy and reliability of the renewable energy production data. The amount of renewable energy recorded by the meter 306 may be used for future performance analysis of, for example, the list of renewable energy generation devices 114, and forecasting of future renewable energy production. Thereafter, the sensor circuit board 308 connected to the data acquisition circuit 304 and the meter 306, where the sensor circuit board 308 is communicatively coupled to one or more sensors configured to generate sensor information indicative of on-the-ground ambient conditions that exist during renewable energy production at the renewable energy production source site 118 influencing production of renewable energy. The on-the-ground ambient conditions may have a direct impact on production of renewable energy. The on-the-ground ambient conditions may include a weather condition, an air quality condition, a wind speed parameter, an air temperature parameter, and the like. In an implementation, the renewable energy metering and monitoring device 104A may utilize a simulation-based approach to create a model of the solar irradiations for the renewable energy production source site 118. The solar irradiations model can be made by measuring the surface location on an annual, long-term, or short-term basis. This is achieved by collecting data from the list of renewable energy generation devices 114, as well as adjacent or nearby installations (i.e., renewable energy production source sites). The collected data is used to create the solar irradiations model, which is used to monitor the performance, such as productivity and efficiency of the list of renewable energy generation devices 114. In the creation of the solar irradiations model, various factors, such as season type, short-term weather variability and long-term weather variability, are considered. The purpose of creating the solar irradiations model is to accurately determine the on-the-ground ambient conditions that either or indirectly affect the performance of the list of renewable energy generation devices 114. Such information has a great significance for ranking competing areas and sites for establishing solar renewable energy projects, maximizing the renewable energy generation and making informed decisions regarding appropriate equipment selection for renewable energy generation at commercial scale.

The controller 310 of the renewable energy metering and monitoring device 104A may be configured to communicate the plurality of renewable energy production datasets 208 to the central cloud server 102. In response to, the central cloud server 102 may be configured to generate the electronically verifiable span data package 134 using the plurality of renewable energy production datasets 208 which is then processed to generate a REC claim request in a defined taxonomy compatible to be read by the API 122 of the first third-party system 120. The electronically verifiable span data package 134 may include the first type of data item and the second type of data item, have been described in detail, for example, in FIGS. 1A, and 5. The central cloud server 102 may further be configured to generate and communicate the REC claim request for initiating the process of generating the interactive DIGIREC asset 144.

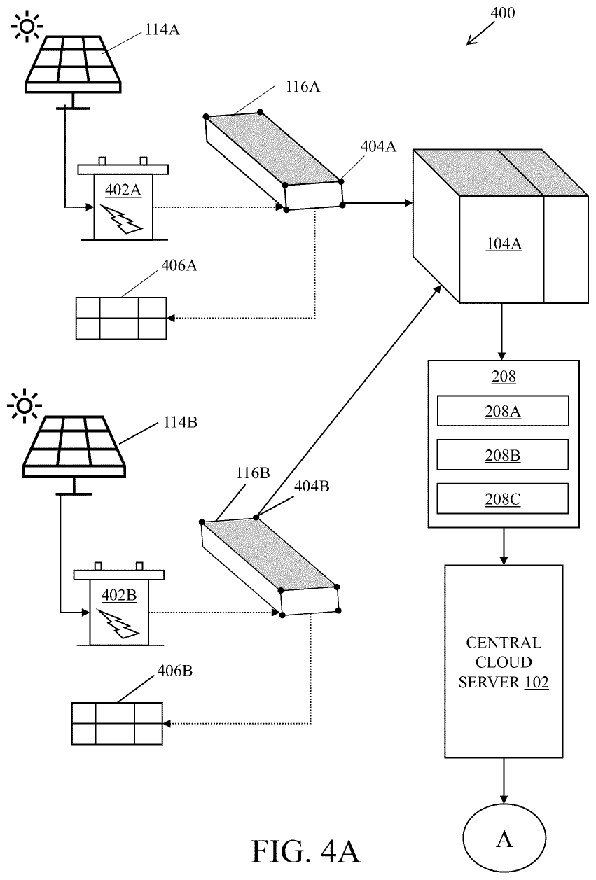

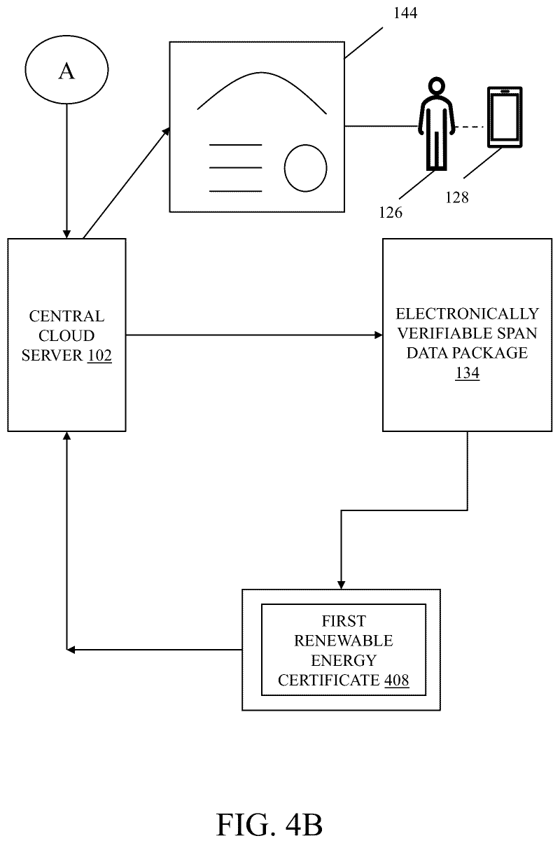

FIGS. 4A and 4B collectively, is a diagram illustrating an exemplary implementation scenario of a flow of issuing an interactive DIGIREC asset for electricity corresponding to generation of a relative unit of electricity using renewable energy, in accordance with an embodiment of the present disclosure. FIGS. 4A and 4B are described in conjunction with the elements of FIGS. 1A, 1B, 2, and 3. With reference to FIGS. 4A and 4B, there is shown an exemplary implementation scenario 400 of a flow of issuing an interactive DIGIREC asset (e.g., the interactive DIGIREC asset 144) for electricity corresponding to generation of a relative unit of electricity using renewable energy. With reference to FIG. 4A, there is shown the first renewable energy generation device 114A, the second renewable energy generation device 114B, a first battery 402A, a second battery 402B, a first data port 404A on the first inverter 116A, a second data port 404B on the second inverter 116B, the renewable energy metering and monitoring device 104A, the central cloud server 102, a first renewable energy production dataset 208A, a second renewable energy production dataset 208B, and a third renewable energy production dataset 208C of the plurality of renewable energy production datasets 208, a first output load 406A and a second output load 406B. With reference to FIG. 4B, there is shown the central cloud server 102, the electronically verifiable span data package 134 (of FIG. 1B), a first REC 408, the interactive DIGIREC asset 144, the registered entity 126 and the user device 128.

Referring to FIG. 4A, in the exemplary implementation scenario 400, each of the first renewable energy generation device 114A and the second renewable energy generation device 114B is considered as a solar panel in an example. However, it is understood that each of the first renewable energy generation device 114A and the second renewable energy generation device 114B may correspond to any source of renewable energy, such as a wind turbine, a tidal turbine, a hydroelectric dam, a biomass power plant, a geothermal power plant, a solar water heater, a wave energy converter, and the like. The first renewable energy generation device 114A and the second renewable energy generation device 114B may be installed at the renewable energy production source site 118 for renewable energy generation.

Each of the first battery 402A and the second battery 402B may be referred to as a storage system used for storing renewable energy generated by the first renewable energy generation device 114A and the second renewable energy generation device 114B. The first battery 402A and the second battery 402B may be configured to ensure a continuous power supply to the first output load 406A and the second output load 406B, particularly during time-periods when solar energy is unavailable, by storing excess energy for later use. Examples of implementation of each of the first battery 402A and the second battery 402B may include, but are not limited to, a lithium-ion battery, a lead-acid battery, a power wall, a flow battery, and the like.

Each of the first output load 406A and the second output load 406B may refer to any electrical device, equipment, or appliance that consumes electricity at the renewable energy production source site 118. Alternatively stated, each of the first output load 406A and the second output load 406B relies on the renewable energy, generated using the first renewable energy generation device 114A and the second renewable energy generation device 114B, stored the generated renewable energy into the first battery 402A and the second battery 402B, and converted into AC electricity using the first inverter 116A and the second inverter 116B, for their operational requirements.

Each of the first inverter 116A and the second inverter 116B may be configured to convert DC electricity from the first battery 402A and the second battery 402B, respectively, to AC electricity, compatible for use in the first output load 406A and the second output load 406B. In addition, the first inverter 116A and the second inverter 116B may be configured to regulate the voltage and frequency of the AC electricity, supplied to the first output load 406A and the second output load 406B.

The renewable energy metering and monitoring device 104A is communicatively coupled to each of the first inverter 116A and the second inverter 116B through the first data port 404A and the second data port 404B, respectively. The renewable energy metering and monitoring device 104A may be configured to receive renewable energy production data from the first inverter 116A and the second inverter 116B through the first data port 404A and the second data port 404B, respectively. The renewable energy production data may include, but not be limited to, an amount of renewable energy generated by each of the first renewable energy generation device 114A and the second renewable energy generation device 114B, a duration of the renewable energy generation, and identification information of each of the first renewable energy generation device 114A and the second renewable energy generation device 114B, and each of the first inverter 116A and the second inverter 116B. The renewable energy metering and monitoring device 104A may be configured to transform the renewable energy production data into the plurality of renewable energy production datasets 208.

The central cloud server 102 may be configured to acquire the plurality of renewable energy production datasets 208 from the renewable energy metering and monitoring device 104A. The plurality of renewable energy production datasets 208 may include the first renewable energy production dataset 208A, the second renewable energy production dataset 208B and the third renewable energy production dataset 208C.

Now referring to FIG. 4B, the central cloud server 102 may be configured to assign the timestamp and the hash value to each renewable energy production dataset of the plurality of renewable energy production datasets 208 and generate the electronically verifiable span data package 134. The electronically verifiable span data package 134 is then processed to generate a REC claim request (also referred to as REC claim) in a defined taxonomy compatible to be read by the API 122 of the first third-party system 120.

The central cloud server 102 may further be configured to trigger and communicate the REC claim request along with a portion of the electronically verifiable span data package 134 as evidence to initiate the issuance of the first REC 408. The central cloud server 102 may further be configured to communicate with the first third-party system 120 (of FIG. 1A) to verify the renewable energy production data in the REC claim request. On successful verification of the REC claim request, the central cloud server 102 may further be configured to acquire, from the first third-party system 120, a unique identifier of the first REC 408 issued by the REC issuing entity 108. The central cloud server 102 may further be configured to generate the interactive DIGIREC asset 144 based on predefined REC-taxonomy metadata 210 (of FIG. 2) and the acquired unique identifier. The interactive DIGIREC asset 144 is associated with an ownership to the registered entity 126 of the renewable energy production source site 118. The generation of the interactive DIGIREC asset 144 may ensure that the information contained within the first REC 408, is securely captured, and represented in a digital format.

The central cloud server 102 may be further configured to embed ancillary information in an encrypted form in the interactive DIGIREC asset 144. The encryption of the ancillary information may ensure that any sensitive data related to the certificate's production is protected from any unauthorized access or tampering and thus maintaining the integrity and confidentiality of the information comprised in the interactive DIGIREC asset 144.

FIG. 5 is a diagram illustrating an electronically verifiable span data package, in accordance with an embodiment of the present disclosure. FIG. 5 is described in conjunction with elements of FIGS. 1A, 1B, 2, 3, 4A and 4B. With reference to FIG. 5, there is shown the electronically verifiable span data package 134 that may include a first type of data item 502 and a second type of data item 504.

The first type of data item 502 may have a first data structure 514 with different values and data extensions (e.g., a first value 506A, a second value 506B, a third value 506C, a first data extension 508A, a second data extension 508B, a version placeholder 510, a monitoring, reporting and verification (MRV) extension, simply referred to as MRV extension 512). The second type of data item 504 may be an evidence file that may include different data sources and corresponding data files (e.g., a first source 516A, a second source 516B, a third source 516C, a first data file 518A, a second data file 518B and a third data file 518C). The first data file 518A may be associated with the first source 516A, the second data file 518B may be associated with the second source 516B and the third data file 518C may be associated with the third source 516C.

The first type of data item 502 and the second type of data item 504 may be stored as a checkpoint, which is a tamper-resilient record of the renewable energy data production data associated with the one or more inverters 116 and the list of renewable energy generation devices 114 (of FIG. 1A). The checkpoint can be structured to be the data values, structure, and amount of data that is specified as a predetermined structure that meets the requirement for a particular REC claim. The electronically verifiable span data package 134 may be used for submission as evidence and checkpoint for the REC claim. In an implementation, the first type of data item 502 may further include the REC claim information details, such as a claim date of the REC claim request 138, a checkpoint source, a data structure related to the defined taxonomy, a fuel type indicative of a type of renewable energy used, a production capacity of the renewable energy production source site 118, an identifier of the renewable energy production source site 118, and an account information associated with the renewable energy production source site 118 assigned by the renewable energy verifier entity 106.

The first value 506A, the second value 506B and the third value 506C may be a specific data type within the first type of data item 502. In addition, each of the first data extension 508A and the second data extension 508B may be configured to store additional information associated with the first type of data item 502. In an implementation, each of the first data extension 508A and the second data extension 508B may provide supplementary information relevant to a REC issuing entity code, or renewable energy verifier entity code, or methodology used in the REC-claim.

The version placeholder 510 may refer to a defined version of data format being used in the first type of data item 502. In an example, a version “1.0” may suggest that this is the first version of the first type of data item 502. In addition, the MRV extension 512 may be a specific type of data extension which is used for monitoring, reporting and verification (MRV) purposes. In an implementation, the MRV extension 512 may provide details relevant to the relevant REC issuing entity code used for the issuance of the interactive DIGIREC asset 144.

In an example, a structure of the first type of data item 502 may be described as shown in Table 1:

TABLE 1
The first type of data item 502

```
      {
      “manifest”: {
          “id”: “ab0ec8e8-6cd0-40b7-92b7-cbae0d08ae37”,
          “version”: “1.0”,
          “aioId”: “0117417a-9763-48e1-88e8-6a7e937c3cb1”,
          “aimId”: “3e343ef2-e700-4b34-a23f-5a6499004ede”,
          “claimId”: “15ed8e5c-b05a-4bc6-adf5-9dac98bfea00”,
          “projectDeveloperId”: “f5d17f74-95f7-4178-9206-9f3bffc3b736”,
          “created”: {
            “date”: {
              “dateString”: “2023-11-27”
            }
          },
          “mrvExtensions”: [
  {
    “mrvExtensionContext”: “SDP_MANIFEST_MRV_EXTENSION”,
    “untypedExtension”: {
      “name”: “C-Pesa REC Data Extension”,
      “version”: “1.0”,
      “description”: “C-Pesa REC Data Extension holds data values specific to the relevant
REC issuing entity code or methodology being followed.”,
      “dataExtensions”: [
        {
          “key”: “Checkpoint Source”,
          “value”: “Inverter: 147e7105-2333-4f5f-847c-6c984e5220dd: m350206220”
        }
                “sdpFiles”: [
            {“name”: “147e7105-2333-4f5f-847c-6c984e5220dd.json”,
              “type”: “DATA_JSON”,
              “description”: “Evidence from C-Pesa Box: m350206220”,
              “claimSourceId”: “147e7105-2333-4f5f-847c-6c984e5220dd”,
              “claimSourceAttestation”: “digital signature”,
              “mrvExtensions”: [
                {
                  “mrvExtensionContext”: “AIM_CLAIM_SOURCE_MRV_EXTENSION”,
                  “untypedExtension”: {
                    “name”: “C-Pesa-Device”,
                    “version”: “1.0.0”,
                    “description”: “C-Pesa Verifier_ Device Extension to hold values needed for
      Verifier_ for Registered Devices in ECS”,
                    “dataExtensions”: [
                      {
                        “key”: “ResourceValuesToQuery”,
                        “value”:
      “device_id,values_id,e_03_07_00_999_Planned_Energy_Output,e_00_02_00_001_AC
      _voltage,e_00_03_00_001_AC_current,e_00_05_00_001_AC_activepower,e_00_02_0
      0_001_DC_busvoltage,i_00_06_00_001_Syn_frequency,e_00_16_00_001_operatingti
      me,e_00_16_00_001_total_runningtime,e_03_07_00_001_power_consumption,e_03_0
      1_00_000_total_solar_power,e_03_01_00_000_total_other_power,e_03_07_04_000_to
      tal_load_energy,e_03_07_04_001_AC_import_energy,e_03_07_04_001_AC_export_e
      nergy,e_03_08_04_001_AC_import_reactiveenergy,e_03_08_04_001_AC_export_reac
      tiveenergy,e_03_07_00_003_AC_energy,e_03_07_00_003_AC_energy_daily,e_00_16
      _00_003_inverter_runningtime,e_00_16_00_003_inverter_feedintime”
                      },
                      {
                        “key”: “Verifier_Properties”,
                        “value”: “v1.0”,
                        “data”: [
                          { “key”: “Verifier_DeviceId”,
                            “value”: “OJIJES10001”
                          },
                          {
                            “key”: “Verifier_DeviceUId”,
                            “value”: “01HA7GH8Y9CD7AEDY40SVP1AMF”
                              {
                            “key”: “Verifier_DeviceName”,
                            “value”: “Ojijo_Device_1”
                          },
                          {
                            “key”: “Verifier_FuelType”,
                            “value”: “ES-100 Solar”
                          },
                          {
                            “key”: “Verifier_DeviceTechnology”,
                            “value”: “TC110 - PV Ground mounted”
                          },
                          {
                            “key”: “Verifier_DeviceCapacity”,
                            “value”: “2.00000 MW”
                          },
                          {
                            “key”: “Verifier_CommissioningDate”,
                            “value”: “2023/07/01”
                          },
                          {
                            “key”: “Verifier_DefaultAccountCode”,
                            “value”: “ETAP92WN”
                {
                  “mrvExtensionContext”:
                  “mrvExtensionContext”: “SDP_FILE_MRV_EXTENSION”,
                  “untypedExtension”: {
                    “name”: “ECS Span Data Package File Metadata”,
                    “version”: “1.0.0”,
                    “description”: “Basic file information for an ECS Span Data Package”,
                    “dataExtensions”: [
                      {
                        “key”: “File Name”,
                        “value”: “147e7105-2333-4f5f-847c-6c984e5220dd.json”
                      },
                      {
                        “key”: “File Size”,
                        “value”: “544481”
                      },
                      {
                        “key”: “File Type”,
                        “value”: “.json”
                      },
                      {
                        “key”: “File Created”,
                        “value”: “11/27/2023 20:57:49”
                      },
                      {
                        “key”: “File Modified”,
                        “value”: “11/27/2023 20:57:49”
                      },
                      {
                        “key”: “File Accessed”,
                        “value”: “11/27/2023 20:57:49”
                      }
```

In the above example, the first type of data item 502 may include information about the REC claim that was created on Nov. 27, 2023. The claim ID is 15ed8e5c-b05a-4bc6-adf5-9dac98bfea00. The source data file is named “147e7105-2333-4f5f-847c-6c984e5220dd.json” and it contains data from the one or more inverters 116.

The second type of data file 504 may include the evidence to support the REC claim. The second type of data item 504 may include a list of device identities (IDs) and corresponding renewable energy production data associated with each device ID over a specified period as source evidence. The source evidence may come from a variety of sources, such as the first source 516A, the second source 516B and the third source 516C. The first source 516A, the second source 516B and the third source 516C may provide an origin of the second type of data item 504. The first source 516A, the second source 516B and the third source 516C may be a device, or a system that generates the second type of data item 504. In addition, the first data file 518A, the second data file 518B and the third data file 518C may include renewable energy production data. The renewable energy production data is associated with the one or more inverters 116 and the list of renewable energy generation devices 114 for a specific period.

In an example, a structure of the second type of data item 504 may be described as shown in Table 2:

TABLE 2
The second type of data item 504

```
{
  “data”: [
    {
      “timestamp”: “2023-11-05T00:00:52+00:00”,
      “device_id”: “m350206136”,
      “values_id”: “001”,
      “e_03_07_04_001_AC_import_energy”: 0.099,
      “e_03_07_04_001_AC_export_energy”: 1040.128,
      “e_03_08_04_001_AC_import_reactiveenergy”: 0.394,
      “e_03_08_04_001_AC_export_reactiveenergy”: 14.875
    },
{
      “timestamp”: “2023-11-05T00:03:11+00:00”,
      “device_id”: “m350206136”,
      “values_id”: “001”,
      “e_03_07_04_001_AC_import_energy”: 0.099,
      “e_03_07_04_001_AC_export_energy”: 1040.128,
      “e_03_08_04_001_AC_import_reactiveenergy”: 0.394,
      “e_03_08_04_001_AC_export_reactiveenergy”: 14.875
    },
    {
      “timestamp”: “2023-11-05T00:03:57+00:00”,
      “device_id”: “m350206136”,
      “values_id”: “000”,
      “e_03_01_00_000_total_solar_power”: 0.0
    },
    {
      “timestamp”: “2023-11-05T00:08:37+00:00”,
      “device_id”: “m350206136”,
      “values_id”: “000”,
      “e_03_01_00_000_total_solar_power”: 0.0
    },
    {
      “timestamp”: “2023-11-05T00: 14:52+00:00”,
      “device_id”: “m350206136”,
      “values_id”: “001”,
      “e_03_07_04_001_AC_import_energy”: 0.099,
      “e_03_07_04_001_AC_export_energy”: 1040.128,
      “e_03_08_04_001_AC_import_reactiveenergy”: 0.394,
      “e_03_08_04_001_AC_export_reactiveenergy”: 14.876 }
```

The data structure of each of the first type of data item 502 and the second type of data item 504 provides the opportunity to retrieve the renewable energy production data at a later date, such as a month, year, etc. to review and confirm the underlying data that is the source of the verification (and the issued first REC). A third party, such as an auditor can be provided with access rights through a portal to check the data and verify that the hash and related are correct and properly verified. If there is an error, it can generate an indication that the source data is improperly manipulated or generated.

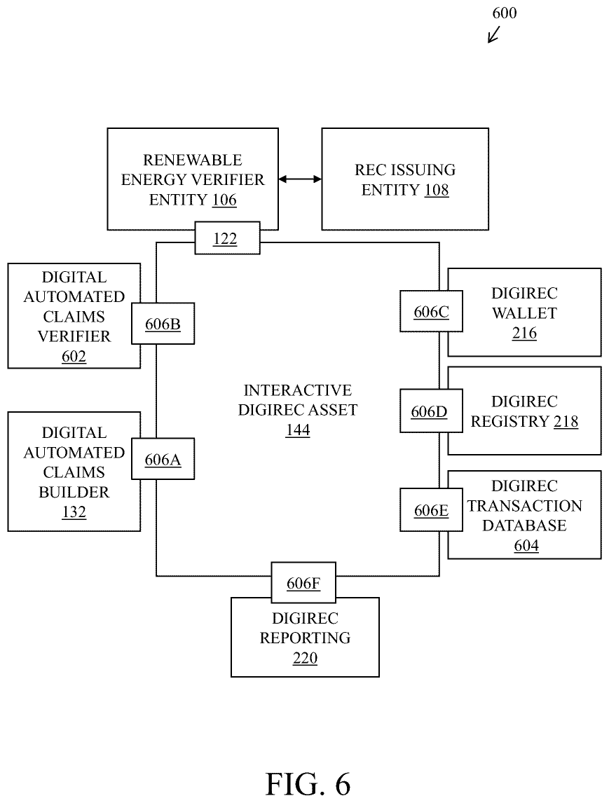

FIG. 6 is a diagram illustrating lifecycle of an interactive DIGIREC asset for electricity, in accordance with an embodiment of the present disclosure. FIG. 6 is described in conjunction with elements of FIGS. 1A, 1B, 2, 3, 4A, 4B, and 5. With reference to FIG. 6, there is shown a life cycle 600 of the interactive DIGIREC asset 144 (of FIG. 1B). There is shown a digital automated claims verifier 602 and a DIGIREC transaction database 604. There is further shown a number of APIs, such as a first API 606A, a second API 606B, a third API 606C, a fourth API 606D, a fifth API 606E, and a sixth API 606F. The digital automated claims verifier 602 corresponds to the digital automated claims verifier 162 (of FIG. 1B).

In an implementation, the digital automated claims builder 132 may be configured to continuously read renewable energy production data comprising the plurality of renewable energy production datasets 208 from the renewable energy metering and monitoring device 104A through the first API 606A. In response, the digital automated claims verifier 162 may be configured to generate and communicate REC claim request to the first-third party system 120 associated with the renewable energy verifier entity 106 through the API 122. In response to receiving the REC claim request, the digital automated claims verifier 602 may be configured to pre-validate the information comprised in the REC claim request in accordance with a corresponding standard or code for that certificate (e.g., the renewable energy verifier entity 106 code or REC issuing entity code). If the information is pre-validated based on its processing operations and algorithms, the digital automated claims verifier 602 may be configured to forward the validated REC claim request to the first-third party system 120 associated with the renewable energy verifier entity 106 through the API 122. The pre-validation of the REC claim request may include validating the plurality of renewable energy production datasets 208 using one or more defined checkpoints prior to actual verification of the REC claim request by the first third-party system 120 associated with the renewable energy verifier entity 106. In an implementation, the second API 606B and the API 122 may be the same APIs. In another implementation, the second API 606B and the API 122 may be different APIs. Thereafter, the first-third part system 120 may be configured to verify the REC claim request. On successful verification of the REC claim request, the first third-party system 120 is configured to facilitate issuance of the first REC 408 (of FIG. 4B) in coordination with the REC issuing entity 108. The first third-party system 120 may be configured to communicate a unique identifier of the first REC 408 back to the digital automated claims verifier 162 through the API 122. In other words, the digital automated claims verifier 162 may be configured to acquire the unique identifier of the first REC 408 (issued by the REC issuing entity 108) from the first third-party system 120 through the API 122. Thereafter, the digital automated claims verifier 162 may be configured to generate the interactive DIGIREC asset 144 based on the predefined REC taxonomy metadata 210 (of FIG. 2) and using the acquired unique identifier.

The interactive DIGIREC asset 144 may be associated with the DIGIREC wallet 216 through the third API 606C, the DIGIREC registry 218 through the fourth API 606D, the DIGIREC transaction database 604 through the fifth API 606E, and the DIGIREC reporting 220 through the sixth API 606F, respectively. Each of the DIGIREC wallet 216, the DIGIREC registry 218 and the DIGIREC reporting 220 has been described in detail, for example, in FIG. 2. In an implementation, each of the third API 606C, the fourth API 606D, the fifth API 606E, and the sixth API 606F may be the same API. In another implementation, each of the third API 606C, the fourth API 606D, the fifth API 606E, and the sixth API 606F may be different APIs.

The DIGIREC transaction database 604 may be configured to communicate with REC tradeable exchanges, for example, using the FIX protocol, which may be a messaging protocol used to exchange financial information between one or more buyers of the interactive DIGIREC asset 144.

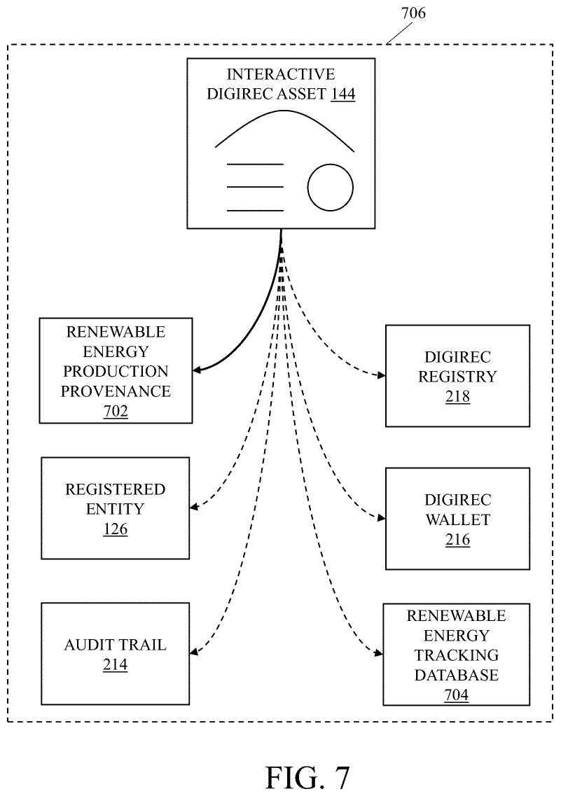

FIG. 7 is a diagram illustrating various features of an interactive DIGIREC asset, in accordance with an embodiment of the present disclosure. FIG. 7 is described in conjunction with elements of FIGS. 1A, 1B, 2, 3, 4A, 4B, 5 and 6. With reference to FIG. 7, there is shown various provenance functions, such as a renewable energy production provenance 702, the registered entity 126, the audit trail 214, a renewable energy tracking database 704, the DIGIREC wallet 216 and the DIGIREC registry 218, associated with the interactive DIGIREC asset 144.

In an implementation, the interactive DIGIREC asset 144 may be visualized on a user interface (UI) 706. The UI 706 may be part of the front-end interface 112A and can be remotely accessed by a user using a user device when authorized by the central cloud server 102. A user may provide a user input, for example, a voice command, or by pressing or clicking the interactive DIGIREC asset 144 to visualize and access various provenance functions associated with the interactive DIGIREC asset 144. Examples of the user input may include, but are not limited to a mouse input, a keyboard input, a voice command, a biometric input, a sensor input, or any other input to the UI 706). Examples of the provenance functions include, but are not limited to the renewable energy production provenance 702, the registered entity 126, the audit trail 214, the renewable energy tracking database 704, the DIGIREC wallet 216 and the DIGIREC registry 218 associated with the interactive DIGIREC asset 144.

The renewable energy production provenance 702 may be displayed as an UI element when a user input is provided on the interactive DIGIREC asset 144. When the user input is provided on UI element corresponding to the renewable energy production provenance 702, an assurance of an authenticity and provenance about production of a unit of electricity through renewable energy as claimed in the interactive DIGIREC asset 144, may be provided at an atomic level. For example, renewable energy production provenance 702 may indicate granular information, such as identity of the renewable energy production source site 104, the identities of each of the one or more inverters 116, sensor information indicative of on-the-ground ambient conditions that exist during renewable energy production, such as wind speed, air pressure, humidity, temperature, solar radiations, terrain conditions, and the like, a timestamp and hash value assigned to each of the plurality of renewable energy production datasets 208, and how many kWh of electricity generated at which renewable energy production source site, each day. An exemplary structure of such information is shown in Table 3.

TABLE 3

| | | Energy | Cumulative | | Metering and | | | |
|---|---|---|---|---|---|---|---|---|
| | Time | Prod. | Energy | Inverter | Monitoring | Hash | Ambient | Data |
| Site_ID | stamp | (kWh) | (kWh) | ID | Device ID | Value | Condition | Assurance |
| SITE- | 2023-04-01 | 0.000 | 0.000 | INV- | DEV-001 | 0x000000 | Temperature: | 1 |
| 001 | 00:00:00 | | | 001 | | 00000000 | 22° C., Wind | |
| | | | | | | 00000000 | Speed: 5 km/h, | |
| | | | | | | 00000000 | Solar | |
| | | | | | | 00000000 | Irradiance: | |
| | | | | | | 00000000 | 0 W/m² | |
| | | | | | | 00000000 | | |
| | | | | | | 00000000 | | |
| | | | | | | 00 | | |
| SITE- | 2023-04-01 | 6.250 | 6.250 | INV- | DEV-001 | 0x9c8c8b | Temperature: | 1 |
| 001 | 00:15:00 | | | 001 | | 7c7d8d8e | 22° C., Wind | |
| | | | | | | 8f9a9b9c | Speed: 6 km/h, | |
| | | | | | | 9d9e9f9a | Solar | |
| | | | | | | 9b9c9d9e | Irradiance: | |
| | | | | | | 9f9a9b9c | 500 W/m² | |
| | | | | | | 9d9e9f9a | | |
| | | | | | | 9b9c9d9e | | |
| | | | | | | 9f | | |
| SITE- | 2023-04-01 | 8.750 | 15.000 | INV. | DEV-001 | 0x1a2b3c | Temperature: | 1 |
| 001 | 00:30:00 | | | 001 | | 4d5e6f7a | 23° C., Wind | |
| | | | | | | 8b9c0d1e | Speed: 7 km/h, | |
| | | | | | | 2f3a4b5c | Solar | |
| | | | | | | 6d7e8f9a | Irradiance: | |
| | | | | | | 0b1c2d3e | 600 W/m² | |
| | | | | | | 4f5a6b7c | | |
| | | | | | | 8d9e0f1a | | |
| | | | | | | 2b | | |
| . . . | . . . | . . . | . . . | . . . | . . . | . . . | . . . | . . . |
| SITE- | 2023-04-01 | 10.000 | 490.000 | INV- | DEV-001 | 0x3c4d5e | Temperature: | 1 |
| 001 | 23:45:00 | | | 001 | | 6f7a8b9c | 20° C., Wind | |
| | | | | | | 0d1e2f3a | Speed: 10 km/h, | |
| | | | | | | 4b5c6d7e | Solar | |
| | | | | | | 8f9a0b1c | Irradiance: | |
| | | | | | | 2d3e4f5a | 100 W/m² | |
| | | | | | | 6b7c8d9e | | |
| | | | | | | 0f1a2b3c | | |
| | | | | | | 4d | | |
| SITE- | 2023-04-02 | 8.750 | 1000.00 | INV- | DEV-001 | 0x5e6f7a | Temperature: | 1 |
| 001 | 00:00:00 | | | 001 | | 8b9c0d1e | 19° C., Wind | |
| | | | | | | 2f3a4b5c | Speed: 8 km/h, | |
| | | | | | | 6d7e8f9a | Solar | |
| | | | | | | 0b1c2d3e | Irradiance: | |
| | | | | | | 4f5a6b7c | 0 W/m² | |
| | | | | | | 8d9e0f1a | | |
| | | | | | | 2b3c4d5e | | |
| | | | | | | 6f | | |

Table 3 shows exemplary renewable energy production data at 15-minute intervals for a single day in an example. The “Site_ID” column with the value “SITE-001” for all rows, represents the identity of the renewable energy production source site 118. The “Energy Production (kWh)” column displays the renewable energy generated during each 15-minute interval in kilowatt-hours (kWh). The “Cumulative Energy (kWh)” column keeps a running total of the energy produced, which reaches 1,000 kWh or 1 MW at the end of the day. The “Inverter ID” column with the value “INV-001” for all rows, represents the inverter (e.g., the first inverter 116A) that converted the DC electricity to AC. The “Metering and Monitoring Device ID” column with the value “DEV-001” for all rows, represents the renewable energy metering and monitoring device (e.g., the renewable energy metering and monitoring device 104A) that is configured to monitor, record and verify the AC electricity generated by the inverter. The “Ambient Conditions” column may have sample values for temperature, wind speed, and solar irradiance at each timestamp. These values represent the environmental conditions on the ground at the time of renewable energy production. Furthermore, each row now includes a unique hash value represented as a hexadecimal string. The hash values are intended to represent the output of a cryptographic hash function applied to the corresponding renewable energy production dataset by the central cloud server 102. The “Data Assurance” column provides a consistent message to the user, indicating that the data is recorded by a certified meter (e.g., the meter 306) and data acquisition system (e.g., the data acquisition circuit 304), ensuring its accuracy and reliability. A value of “1” is assigned to the “Data Assurance” column, which signifies that no tampering is performed on the recorded data and that the recorded data is verified by independent auditors. If any tampering or data integrity issues are detected during the verification and auditing processes, the “Data Assurance” could be set to a different value (e.g., 0 or −1) to indicate potential issues with the data. By having a dedicated column for the data assurance indicator, it becomes easier to filter or identify rows where the data may have been compromised or require further investigation or verification.

In an implementation, the registered entity 126 may be further displayed as a UI element when a user input is provided on the interactive DIGIREC asset 144. When the user input is provided on the UI element corresponding to the registered entity 126, it may be ascertained when and where the interactive DIGIREC asset 144 was generated and by whom. For example, initially, the ownership of the interactive DIGIREC asset 144 is associated with the registered entity 126. Later on, the registered entity 126 may trade (or sell) the interactive DIGIREC asset 144 to another entity, for example, a registered entity X in a country X and after some time, the registered entity X sells the interactive DIGIREC asset 144 to a registered entity Y in a country Y before the expiry of validity period of the interactive DIGIREC asset 144. The information associated with the different registered entities including country name may be stored, managed and accessed from the DIGIREC registry 218. Further, the DIGIREC wallet 216 may provide all the details related to different payment methods, websites or passwords used in trading of the interactive DIGIREC asset 144.

In an implementation, the audit trail 216 may be further displayed as a UI element when a user input is provided on the interactive DIGIREC asset 144. When the user input is provided on UI element corresponding to the audit trail 216, a sequence of audit associated with renewable energy production claimed in the interactive DIGIREC asset 144, may be validated. For example, identity of the renewable energy verifier entity 106, verification timestamp indicating when audit was done, an audit log may be accessed in addition to the information provided by the renewable energy production provenance 702, as shown in Table 3. In an exemplary scenario, the audit log may include the information related to different audits performed at various levels, for example, audit 0, audit 1, audit 2, audit 3 and audit 4. For example, the audit 0 may correspond to the physical audit which may be done initially to confirm whether the registration of each of the list of renewable energy generation devices 114, and the one or more inverters 116 at the renewable energy production source site 118 is accurately performed or not. The audit 0 may also include the audition of the installation of the renewable energy metering and monitoring device 104A at the renewable energy production source site 118. Similarly, a next audit “audit 1” may correspond to the local pre-validation of the plurality of renewable energy production datasets 208 acquired from the renewable energy metering and monitoring device 104A using one or more defined checkpoints prior to verification of the REC claim request 138 by the first third-party system 120 associated with the renewable energy verifier entity 106. The audit 2 may correspond to the audit done by the first third-party system 120 associated with the renewable energy verifier entity 106 to successfully verify the REC claim request 138. The audit 3 may correspond to the audit done by the first third-party system 120 for issuing a unique identifier associated with the first REC 408. The audit 4 may correspond to the audit done automatically by the central cloud server 102 after embedding the ancillary information 212 in the interactive DIGIREC asset 144. The audit 4 may also confirm the successful embedding of the ancillary information 212 to the interactive DIGIREC asset 144.

In an implementation, the renewable energy tracking database 704 may be further displayed as a UI element when a user input is provided on the interactive DIGIREC asset 144. When the user input is provided on UI element corresponding to the renewable energy tracking database 704, information related to other business data associated with the interactive DIGIREC asset 144 may be ascertained. The renewable energy tracking database 704 may comprise, for each renewable energy production source site, the plurality of renewable energy production datasets 208 indicative of an amount of renewable energy generated, a date and duration when the renewable energy is generated along with supplementary information comprising a location of the renewable energy production source site 118, a fuel type indicative of a type of renewable energy used, an evidence type, and device information of the list of renewable energy generation devices 114 and the one or more inverters 116 registered at the central cloud server 102 for each renewable energy production source site.

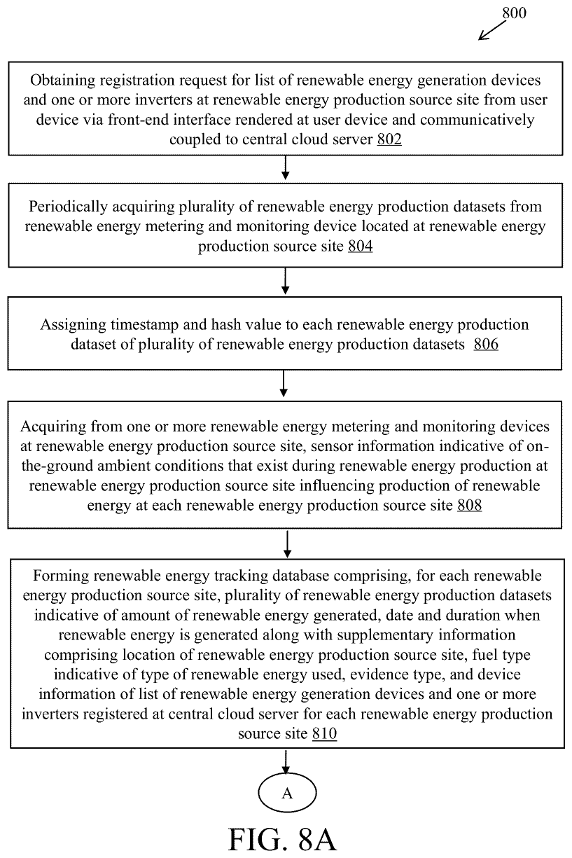

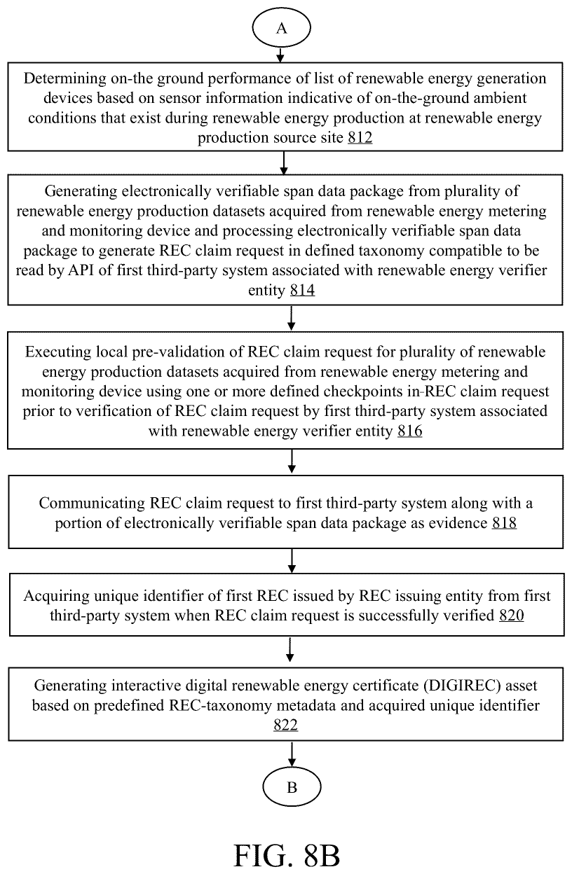

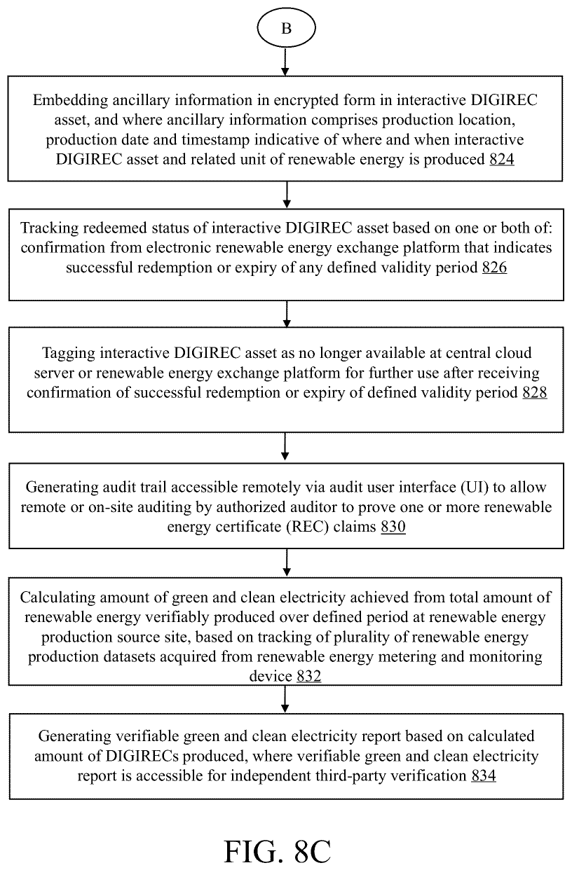

FIGS. 8A, 8B and 8C, collectively is a diagram illustrating a flowchart of a method of immutable electronic processing of renewable energy production data for issuing Digital Renewable Energy Certificates (DIGIRECs) for electricity, in accordance with an embodiment of the present disclosure. FIGS. 8A, 8B and 8C are described in conjunction with elements from FIGS. 1A, 1B, 2, 3, 4A, 4B, 5, 6, and 7. With reference to the FIGS. 8A, 8B and 8C, there is shown a method 800 that includes steps 802 to 834. The central cloud server 102 of the system 100A (of FIG. 1A) is configured to execute the method 800.

Referring to FIG. 8A, at 802, a registration request for a list of renewable energy generation devices (e.g., the list of renewable energy generation devices 114, of FIG. 1A) and one or more inverters (e.g., the one or more inverters 116) installed at a renewable energy production source site (e.g. the renewable energy production source site 118) may be obtained from a user device (e.g., the user device 112) via a front-end interface (e.g., the front-end interface 112A) rendered at the user device 112 and communicatively coupled to a central cloud server (e.g., the central cloud server 102).

At 804, a plurality of renewable energy production datasets (e.g., the plurality of renewable energy production datasets 208, of FIG. 2) may be periodically acquired from a renewable energy metering and monitoring device (e.g., the renewable energy metering and monitoring device 104A) located at the renewable energy production source site 118. The renewable energy metering and monitoring device 104A is communicatively coupled to a corresponding data port of the one or more inverters 116 located at the renewable energy production source site 118.

At 806, a timestamp and a hash value may be assigned to each renewable energy production dataset of the plurality of renewable energy production datasets 208 in order to make each renewable energy production dataset robust to the human errors.

At 808, sensor information indicative of on-the-ground ambient conditions that exist during renewable energy production at the renewable energy production source site 118 influencing production of renewable energy at each renewable energy production source site may be acquired from one or more renewable energy metering and monitoring devices (e.g., the one or more renewable energy metering and monitoring devices 104) at the renewable energy production source site 118. An amount of renewable energy produced by the list of renewable energy generation devices 114 at the renewable energy production source site 118 when converted to alternating current (AC) for electricity via the one or more inverters 116 is read directly by the renewable energy metering and monitoring device 104A in a secured device-to-device communication between the renewable energy metering and monitoring device 104A and the one or more inverters 116.

At 810, a renewable energy tracking database may be formed for each renewable energy production source site. The renewable energy tracking database comprising the plurality of renewable energy production datasets 208 indicative of an amount of renewable energy generated, a date and duration when the renewable energy is generated along with supplementary information comprising a location of the renewable energy production source site 118, a fuel type indicative of a type of renewable energy used, an evidence type, and device information of the list of renewable energy generation devices 114 and the one or more inverters 116 registered at the central cloud server 102 for each renewable energy production source site. The device information comprises two or more of: a unique device identifier of each registered device of the list of renewable energy generation devices 114 and the one or more inverters 116, a unique identifier of the renewable energy metering and monitoring device 104A, a Media Access Control (MAC) or Internet protocol (IP) address of one or more renewable energy metering and monitoring devices 104 at the renewable energy production source site 118, a make and a model of each of the list of renewable energy generation devices 114, or a grid connection status of the renewable energy production source site 118. The renewable energy tracking database further comprises, for each renewable energy production source site, geographical information of the renewable energy production source site 118 including one or more of: satellite-sensed solar irradiation measurements, weather forecast information, site-specific sensed weather condition information, wind speed information, air temperature information, atmospheric pressure information, air quality or pollution information, relative humidity (RH) information, site-specific rainfall information, precipitable water information, snow days information, CoolingDegree Days (CDDs) information; HeatingDegree Days (HDDs) information, terrain information, or data from local weather stations associated with each renewable energy production source site. Furthermore, an amount of energy loss may be predicted for a given geographical location of the renewable energy production source site 118 for a given time period and co-relate with the plurality of renewable energy production datasets 208.

Now, referring to FIG. 8B, at 812, an on-the ground performance of the list of renewable energy generation devices 114 may be determined based on the sensor information indicative of the on-the-ground ambient conditions that exist during renewable energy production at the renewable energy production source site 118.

At 814, an electronically verifiable span data package (e.g., the electronically verifiable span data package 134) is generated using the plurality of renewable energy production datasets 208 acquired from renewable energy monitoring device 104A and further the electronically verifiable span data package 134 is processed to generate a REC claim request in a defined taxonomy compatible to be read by an application programming interface, API (e.g., the API 122) of the first third-party system 120 associated with the renewable energy verifier entity 106.

In an implementation, the electronically verifiable span data package 134 may comprises a first type of data item (e.g. the first type of data item 502, of FIG. 5) comprising REC claim information details, a claim date of the REC claim request, a checkpoint source, a data structure related to the defined taxonomy, a fuel type indicative of a type of renewable energy used, a production capacity of the renewable energy production source site 118, an identifier of the renewable energy production source site 118, and account information associated with the renewable energy production source site 118 assigned by the renewable energy verifier entity 106. The electronically verifiable span data package 134 further comprises a second type of data item (e.g., the second type of data item 504) comprising a plurality of device identities (IDs) and corresponding energy production data associated with each device ID over a specified period as source evidence.

At 816, a local pre-validation of the REC claim request for the plurality of renewable energy production datasets 208 acquired from the renewable energy metering and monitoring device 104A may be executed using one or more defined checkpoints prior to verification of a renewable energy certificate (REC) claim request by a first third-party system (e.g., the first third-party system 120) associated with the renewable energy verifier entity 106.

At 818, a REC claim request (e.g., the REC claim request 138) may be communicated to the first third-party system 120 along with a portion of the electronically verifiable span data package 134 as evidence.

At 820, a unique identifier of a first REC (e.g., the first REC 408) associated with a REC issuing entity (e.g., the REC issuing entity 108) may be acquired from the first third-party system 120 (e.g., via API 122) when the REC claim request is successfully verified.

At 822, an interactive digital renewable energy certificate (DIGIREC) asset (e.g., the interactive DIGIREC asset 144) may be generated based on predefined REC-taxonomy metadata (e.g., the predefined REC-taxonomy metadata 210) and the acquired unique identifier. The interactive DIGIREC asset 144 is associated with an ownership to a registered entity (e.g., the registered entity 126) of the renewable energy production source site 118.

Now referring to FIG. 8C, at 824, ancillary information (e.g., the ancillary information 212) may be embedded in an encrypted form in the interactive DIGIREC asset 144, and where the ancillary information 212 comprises a production location, a production date and timestamp indicative of where and when the interactive DIGIREC asset 144 and related unit of renewable energy is produced.

At 826, a redeemed status of the interactive DIGIREC asset 144 may be tracked based on one or both of: a confirmation from an electronic renewable energy exchange platform that indicates a successful redemption or an expiry of a defined validity period.

At 828, the interactive DIGIREC asset 144 may be tagged as no longer available at the central cloud server 102 or the renewable energy exchange platform for further use after receiving the confirmation of the successful redemption or after the expiry of the defined validity period.

At 830, an audit trail (e.g., the audit trail 216) may be generated, which is accessible remotely via an audit user interface (UI) to allow remote or on-site auditing by an authorized auditor to prove one or more renewable energy certificate (REC) claims, and where the audit trail 216 is generated based on the plurality of renewable energy production datasets 208 acquired periodically from the renewable energy metering and monitoring device 104A located at the renewable energy production source site 118. The audit trail 216 may be generated further based on local sensor data that influence production of renewable energy at each renewable energy production source site obtained from one or more renewable energy metering and monitoring devices 104 at each renewable energy production source site.

At 832, an amount of green and clean electricity achieved from a total amount of renewable energy verifiably produced over a defined period at the renewable energy production source site 118 may be calculated based on a tracking of the plurality of renewable energy production datasets 208 acquired from the renewable energy metering and monitoring device 104A.

At 834, a verifiable green and clean electricity report may be generated based on the calculated amount of DIGIRECs produced, where the verifiable green and clean electricity report is accessible for independent third-party verification.

The step 802 to 834 are only illustrative and other alternatives can also be provided where one or more steps are added, one or more steps are removed, or one or more steps are provided in a different sequence without departing from the scope of the claims herein. Various embodiments and variants disclosed with the aforementioned system (such as the system 100A) apply mutatis mutandis to the aforementioned method 800.

In one aspect, the present disclosure provides a computer program product comprising program instructions for performing the method 800, when executed by one or more processors (e.g., the processor 202 of the central cloud server 102). In a yet another aspect, the present disclosure provides a non-transitory computer-readable storage medium comprising instructions which, when executed by a computer, cause the computer to carry out the method 800 of immutable electronic processing of renewable energy production data for issuing DIGIRECs for electricity.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system of immutable electronic processing of renewable energy production data for issuing Digital Renewable Energy Certificates (DIGIRECs) for electricity, the system comprising:
a central cloud server configured to:
periodically acquire a plurality of renewable energy production datasets from a renewable energy metering and monitoring device located at a renewable energy production source site;
assign a timestamp and a hash value to each renewable energy production dataset of the plurality of renewable energy production datasets;
generate an electronically verifiable span data package from the plurality of renewable energy production datasets and process the electronically verifiable span data package to generate a renewable energy certificate (REC) claim request in a defined taxonomy compatible to be read by an application programming interface (API) of a first third-party system associated with a renewable energy verifier entity;
communicate the REC claim request to the first third-party system along with a portion of the electronically verifiable span data package as evidence;
acquire a unique identifier of a first REC associated with a REC issuing entity from the first third-party system when the REC claim request is successfully verified; and
generate an interactive digital renewable energy certificate (DIGIREC) asset based on predefined REC-taxonomy metadata and the acquired unique identifier, wherein the interactive DIGIREC asset is associated with an ownership to a registered entity of the renewable energy production source site.

2. The system according to claim 1, wherein the renewable energy metering and monitoring device at the renewable energy production source site is communicatively coupled to a corresponding data port of one or more inverters located at the renewable energy production source site.

3. The system according to claim 2, wherein an amount of renewable energy produced by a list of renewable energy generation devices at the renewable energy production source site when converted to alternating current (AC) for electricity via the one or more inverters is read directly by the renewable energy metering and monitoring device in a secured device-to-device communication between the renewable energy metering and monitoring device and the one or more inverters.

4. The system according to claim 1, wherein the generation of the REC claim request is triggered when the plurality of renewable energy production datasets periodically acquired from the renewable energy metering and monitoring device indicates that an individual inverter of one or more inverters has generated a defined amount of renewable energy equal to or greater than a threshold amount or a defined amount of time of renewable energy equal to or greater than a threshold amount.

5. The system according to claim 4, wherein the generation of the REC claim request is triggered when the plurality of renewable energy production datasets periodically acquired from the renewable energy metering and monitoring device indicates that the one or more inverters collectively at the renewable energy production source site has generated a defined amount of renewable energy equal to or greater than a threshold amount or a defined amount of time of renewable energy equal to or greater than a threshold amount.

6. The system according to claim 1, wherein the central cloud server is further configured to execute a local pre-validation of the REC claim request for the plurality of renewable energy production datasets acquired from the renewable energy metering and monitoring device using one or more defined checkpoints prior to verification of the REC claim request by the first third-party system associated with the renewable energy verifier entity.

7. The system according to claim 1, wherein the central cloud server is further configured to embed ancillary information in an encrypted form in the interactive DIGIREC asset, and wherein the ancillary information comprises a production location, a production date and a timestamp indicative of where and when the interactive DIGIREC asset and related unit of renewable energy is produced.

8. The system according to claim 1, wherein the central cloud server is further configured to:
track a redeemed status of the interactive DIGIREC asset based on one or both of: a confirmation from an electronic renewable energy exchange platform that indicates a successful redemption or an expiry of a defined validity period, and
tagging the interactive DIGIREC asset as no longer available at the central cloud server or the renewable energy exchange platform for further use after receiving the confirmation of the successful redemption or after the expiry of the defined validity period.

9. The system according to claim 1, wherein the electronically verifiable span data package comprises a first type of data item comprising REC claim information details, a claim date of the REC claim request, a checkpoint source, a data structure related to the defined taxonomy, a fuel type indicative of a type of renewable energy used, a production capacity of renewable energy production source site, an identifier of the renewable energy production source site, and account information associated with the renewable energy production source site assigned by the renewable energy verifier entity.

10. The system according to claim 9, wherein the electronically verifiable span data package further comprises a second type of data item comprising a plurality of device identities (IDs) and corresponding energy production data associated with each device ID over a specified period as source evidence.

11. The system according to claim 1, wherein the central cloud server is further configured to generate an audit trail accessible remotely via an audit user interface (UI) to allow remote or on-site auditing by an authorized auditor to prove one or more renewable energy certificate (REC) claims, and wherein the audit trail is generated based on the plurality of renewable energy production datasets acquired periodically from the renewable energy metering and monitoring device located at the renewable energy production source site.

12. The system according to claim 11, wherein the audit trail is generated further based on local sensor data that influence production of renewable energy at each renewable energy production source site obtained from one or more renewable energy metering and monitoring devices at each renewable energy production source site.

13. The system according to claim 1, wherein the central cloud server is further configured to obtain a registration request for a list of renewable energy generation devices and one or more inverters at the renewable energy production source site from a user device via a front-end interface rendered at the user device and communicatively coupled to the central cloud server.

14. The system according to claim 13, wherein the central cloud server is further configured to form a renewable energy tracking database comprising, for each renewable energy production source site, the plurality of renewable energy production datasets indicative of an amount of renewable energy generated, a date and duration when the renewable energy is generated along with supplementary information comprising a location of the renewable energy production source site, a fuel type indicative of a type of renewable energy used, an evidence type, and device information of the list of renewable energy generation devices and the one or more inverters registered at the central cloud server for each renewable energy production source site.

15. The system according to claim 14, wherein the device information comprises two or more of: a unique device identifier of each registered device of the list of renewable energy generation devices and the one or more inverters, a unique identifier of the renewable energy metering and monitoring device, a Media Access Control (MAC) or Internet protocol (IP) address of one or more renewable energy metering and monitoring devices at the renewable energy production source site, a make and a model of each of the list of renewable energy generation devices, or a grid connection status of the renewable energy production source site.

16. The system according to claim 14, wherein the renewable energy tracking database further comprises, for each renewable energy production source site, geographical information of the renewable energy production source site including one or more of: satellite-sensed solar irradiation measurements, weather forecast information, site-specific sensed weather condition information, wind speed information, air temperature information, atmospheric pressure information, air quality or pollution information, relative humidity (RH) information, site-specific rainfall information, precipitable water information, snow days information, CoolingDegree Days (CDDs) information; HeatingDegree Days (HDDs) information, terrain information, or data from local weather stations associated with each renewable energy production source site, and wherein the central cloud server is further configured to predict an amount of energy loss for a given geographical location of the renewable energy production source site for a given time period and co-relate with the plurality of renewable energy production datasets.

17. The system according to claim 1, wherein the central cloud server is further configured to acquire, from one or more renewable energy metering and monitoring devices at the renewable energy production source site, sensor information indicative of on-the-ground ambient conditions that exist during renewable energy production at the renewable energy production source site influencing production of renewable energy at each renewable energy production source site.

18. The system according to claim 17, wherein the central cloud server is further configured to determine an on-the ground performance for each renewable energy generation device of a list of renewable energy generation devices based on the sensor information indicative of the on-the-ground ambient conditions that exist during renewable energy production at the renewable energy production source site.

19. The system according to claim 1, wherein the central cloud server is further configured to:
calculate an amount of green and clean electricity achieved from a total amount of renewable energy verifiably produced over a defined period at the renewable energy production source site, based on a tracking of the plurality of renewable energy production datasets acquired from the renewable energy metering and monitoring device; and
generate a verifiable green and clean electricity report based on the calculated amount of DIGIRECs produced, wherein the verifiable green and clean electricity report is accessible for independent third-party verification.

20. A method of immutable electronic processing of renewable energy production data for issuing Digital Renewable Energy Certificates (DIGIRECs) for electricity, the method comprising:
periodically acquiring, by a central cloud server, a plurality of renewable energy production datasets from a renewable energy metering and monitoring device located at a renewable energy production source site;
assigning, by the central cloud server, a timestamp and a hash value to each renewable energy production dataset of the plurality of renewable energy production datasets;
generating, by the central cloud server, an electronically verifiable span data package from the plurality of renewable energy production datasets and processing the electronically verifiable span data package to generate a renewable energy certificate (REC) claim request in a defined taxonomy compatible to be read by an application programming interface (API) of a first third-party system associated with a renewable energy verifier entity;
communicating, by the central cloud server, the REC claim request to the first third-party system along with a portion of the electronically verifiable span data package as evidence;
acquiring, by the central cloud server, a unique identifier of a first REC associated with a REC issuing entity from the first third-party system when the REC claim request is successfully verified; and
generating, by the central cloud server, an interactive digital renewable energy certificate (DIGIREC) asset based on predefined REC-taxonomy metadata and the acquired unique identifier, wherein the interactive DIGIREC asset is associated with an ownership to a registered entity of the renewable energy production source site.
